(19) United States
(12) Patent Application Publication
(10) Pub. No.: US 2025/0043031 A1
(43) Pub. Date: Feb. 6, 2025

(54) NOVEL DRYING METHOD FOR OLIGOSACCHARIDES

(71) Applicant: INBIOSE N.V., Zwijnaarde (BE)

(72) Inventor: Joeri Beauprez, Zwijnaarde (BE)

(21) Appl. No.: 18/717,397

(22) PCT Filed: Dec. 15, 2022
(86) PCT No.: PCT/EP2022/086075

§ 371 Date: Jun. 6, 2024

(30) Foreign Application Priority Data
Dec. 15, 2021 (EP) 21214778.9

(51) Int. Cl. C08B 37/00; C08J 3/12

(52) U.S. Cl. CPC C08B 37/0003; C08J 3/12; C08J 2305/00

(57) ABSTRACT

This disclosure lies in the technical field of drying an oligosaccharide. This disclosure discloses a method for drying an oligosaccharide or mixture of at least two oligosaccharides by using agitated thin film drying (ATFD), wherein the oligosaccharide or each oligosaccharide of the mixture has a degree of polymerization that is lower than 16.

### CROSS REFERENCE TO RELATED APPLICATIONS

This application is a national phase entry under 35 U.S.C. § 371 of International Patent Application PCT/EP2022/086075, filed Dec. 15, 2022, designating the United States of America and published as International Patent Publication WO 2023/111140 A1 on Jun. 22, 2023, which claims the benefit under Article 8 of the Patent Cooperation Treaty to European Union Patent Application Serial No. 21214778.9, filed Dec. 15, 2021.

### TECHNICAL FIELD

This disclosure relates to a method for drying an oligosaccharide or a mixture of at least two oligosaccharides. More specifically, this disclosure is related to a method of agitated thin film drying (ATFD). Even more specifically, this disclosure relates to the drying of milk oligosaccharides or glycans.

### BACKGROUND

To date oligosaccharides are gaining more and more attention. This molecule group is very diverse in chemical structure, and are composed out of a diverse number of monosaccharides, such as glucose, galactose, N-acetylglucosamine, xylose, rhamnose, N-acetylneuraminic acid, N-acetylgalactosamine, galactosamine, glucosamine, glucuronic acid, galacturonic acid, . . . . These oligosaccharides or glycans are macromolecules in nature with a range of important biological activities and widely distributed in all living organisms. These oligosaccharides or glycans play important roles in a variety of normal physiological and pathological processes, such as cell metastasis, signal transduction, intercellular adhesion, inflammation, and immune response.

Economical production of these oligosaccharides or glycans is of utmost importance to fully benefit their biological advantages.

An example of such oligosaccharides are the milk oligosaccharides (MOs), i.e., oligosaccharides that are found in milk of animals such as mammals and humans (Urashima T. et al., 2011; Coppa et al., 2013). A replete amount of milk oligosaccharide structures has been elucidated so far. The majority of milk oligosaccharides found in animals such as mammals and humans comprise lactose at the reducing end (Urashima et al., 2011). Other milk oligosaccharides, for example, comprise N-acetyllactosamine (Gal-β1,4-GlcNAc) or lacto-N-biose (Gal-β1,3-GlcNAc) at the reducing end (Urashima et al., 2011; Wrigglesworth et al., 2020; Urashima et al., 2013; Wei et al., 2018). Such milk, more specifically, human milk, is to date considered as the best food for newborns and infants. It is composed of several fractions of which milk oligosaccharides are the fourth largest fraction. Besides lactose, human milk, as well as milk of other mammals, contains various structurally diverse oligosaccharides that are also known as human milk oligosaccharides (HMOs) (Urashima T. et al., 2011).

Many of these MOs contain a fucose residue, a galactose residue, a N-acetylglucosamine or an N-acetylneuraminic acid residue at their non-reducing end. Furthermore, there are linear as well as branched representatives. Generally, the monosaccharide residues of MOs are D-glucose, D-galactose, N-acetylglucosamine, L-fucose and N-acetylneuraminic acid (the latter also known as sialic acid or lactaminic acid). The importance of MOs for animal and human infant nutrition is directly linked to their biological activities including protection of the neonate from pathogens, supporting development of the infant's immune system and cognitive abilities. In addition, HMOs serve as a substrate for beneficial bacteria like Bifidobacteria or Lactobacilli. HMOs are further known to act as decoys to reduce the risk of infections by bacterial and viral pathogens that adhere to human cells by binding to these cells' surface glycoproteins. Additionally, various HMOs possess an anti-inflammatory effect and act as immunomodulators (e.g., reducing the risk of developing food allergies).

A wide variety of synthesis methods have been developed already, ranging from extraction over chemical synthesis to enzymatic synthesis. These methods are currently least applied, biotechnological fermentative production is nowadays pursued and commercialized. Methods for the production of oligosaccharides are reviewed by Lu et al. (2021), Faijes et al. (2019), Kruschitz et al. (2020), Ghosh et al. (2020), Vera et al. (2021), Walsh et al. (2020), Li et al. (2020), Li and Ye (2020) and are well known for a person skilled in the art. For all production methods the final oligosaccharide is dried to result in a microbial stable product, with a low water activity.

The drying process of saccharides, especially shorter saccharides such as oligosaccharides that are processed within this disclosure (i.e., having a degree of polymerization lower than 16), tends to be complex as these oligosaccharides are in most cases chemically reactive molecules, in contrast to standard primary or secondary alcohols, amides, a-functionalized carboxylic acids, acetals and hemi-acetals. They are redox- and also biologically active and in addition temperature-sensitive. It is hence of crucial importance that such oligosaccharides, such as MOs and HMOs, are not chemically damaged by mechanical stress. High temperature and excessive shear should be avoided. Moreover, in contrast to polysaccharides (such as glucomannan), these shorter oligosaccharides exert a very high solubility in solution and do not readily precipitate, even at high concentrations. The solubility of some milk oligosaccharides in an aqueous solution (25° C.) is 1410 g/L (2′-fucosyllactose; example 15 of WO2018/164937), 400 g/L (Lacto-N-tetraose; EFSA Journal 17(12): e05907), 500 g/L (Lacto-N-neotetraose; EFSA Journal 18(11): e06305), 500 g/L (3′-sialyllactose; EFSA Journal 18(5): e06098) and at least 500 g/L (6′-sialyllactose; EFSA Journal 20(12): e07645).

Furthermore, dissolved oligosaccharides can react chemically by oxidative or reductive conditions. Moreover, the oligosaccharides can undergo intra- and intermolecular substitutions and hydrolysis reactions rendering the oligosaccharides labile, which in extreme cases may even lead to isomerization or disintegration and coloration of the end product, by, for example, the formation of an isomer form at the reducing end of the oligosaccharide or the formation of hydroxymethylfurfural (HMF), which is a well-known sugar decomposition product in literature, occurring when applying too basic, too acidic and/or too hot conditions. (Cammerer et al., 1999; Fagerson, 1969; Wilson, K. et al., 2014; Van der Fels-Klerx, H. J. et al., 2014).

Oligosaccharides are furthermore often formulated in combination with other (active) molecules, such as amino acids, proteins, enzymes, vitamins, fatty acids, lipids, minerals, (poly)saccharides, monosaccharides, or preservatives, many of which are unstable under harsh drying conditions. Examples of products that contain such unstable molecules are infant nutrition, infant formula, baby food, medical nutrition, elderly nutrition, functional foods (such as energy drinks, sports drinks and nutrition, dairy drinks, yoghurts, soft cheeses . . . ), pharmaceutical formulations, pet foods, animal nutrition, supplements, prebiotic supplements, probiotic supplements, synbiotic supplements, etc. These products are either dried as a whole or ingredients are added as a dry pre-mixture, for which ingredients are mixed and dried. Chemical interactions between the different ingredients occur much faster under harsh drying conditions, hence mild drying conditions are more favorable to produce specific pre-mixtures.

A replete number of techniques are available to dry a solution containing a molecule or molecules of interest that are either dissolved, present as a suspension or present as an emulsion. Each drying technique is accompanied with an amount of residual moisture that can influence the macroscopic properties of the molecule(s), such as solubility and hygroscopicity. In addition to the residual moisture, each drying method is accompanied by a specific texture of the material and a particle size, which also influence the macroscopic properties of the material, such as, hygroscopicity and flowability.

Numerous processes are currently used for drying mono-, oligo- and polysaccharides, including crystallization, lyophilization, freeze drying, spray freeze-drying, freeze spray-drying, band or belt drying etc. In particular, spray-drying is often used for drying and for the formulation of carbohydrates or carbohydrate-containing foods (Woo, M. W. et al. 2013; Ishwarya, S. P.,). Herein, a liquid or slurry containing the molecule(s) of interest, such as oligosaccharides (e.g., HMOs), are brought directly into contact with a hot gas. Some of the disadvantages are the risk of dust explosion, high energy requirement and high demand for air. And while the heat contact time is rather short, heat-sensitive molecules (e.g., components that are, for example, present in a dairy solution obtained from an in vitro and/or ex vivo culture of cells) would be affected as described herein by the drying conditions. Other techniques that are currently investigated encompass drum drying (also known as roller drying), wherein the product is applied continuously as a thin film on the underside or top of the drum, while the drum is heated on the inside.

Agitated thin film drying (ATFD) is known in the art. For example, Li et al., 2015 describe the use of ATFD to dry Konjac glucomannan that is a high molecular weight, highly viscous, water-soluble and non-ionic natural polysaccharide derived from roots and tubers of Amorphophallus konjac. Konjac glucomannan is a linear polysaccharide, consisting of β-D-glucose and β-D-mannose residues in a molar ratio of 1:1.6 linked by β-1,4-glycosidic bonds, the acetyl groups along the backbone are located, on average, every 9-19 sugar units at the C-6 position. Konjac glucomannan is a large polysaccharide that easily precipitates even at a low concentration, rendering it suitable for ATFD. In contrast, shorter saccharides such as oligosaccharides that are processed within this disclosure (i.e., having a degree of polymerization lower than 16) are highly soluble in aqueous solutions as depicted earlier and hence the skilled person would not readily consider to use ATFD. It is also for this reason that a solvent is typically used to crystallize such oligosaccharides.

### BRIEF SUMMARY

It was surprisingly found in this disclosure that agitated thin film drying can be used for drying oligosaccharides having a degree of polymerization lower than 16 such as milk oligosaccharides (mammalian and human milk oligosaccharides). Further, while browning of the obtained powder is a frequent issue observed in commonly applied drying methods such as spray drying, white to off-white powder was successfully obtained when applying ATFD to solutions containing oligosaccharide(s) having a degree of polymerization lower than 16. The method of agitated thin film drying of this disclosure for drying oligosaccharides having a degree of polymerization lower than 16, represents a simpler, safer and more energy efficient method at a lower cost compared to the aforementioned drying techniques known in the art. This is particularly relevant for drying oligosaccharides processed within this disclosure such as MOs and HMOs that need a special care for drying due to their properties as outlined herein. It allows drying at reduced temperatures in a closed system so that emissions and water vapor can be captured, and furthermore preserves the chemical integrity of temperature and sheer sensitive products, which adds to the final product quality and allows to combine the oligosaccharide products with other heat- and/or sheer-labile products such as amino acids, proteins, enzymes, vitamins, fatty acids, lipids, minerals, (poly)saccharides, monosaccharides, or preservatives in a premix. Because of its efficient water removal capacity, multi-step drying processes may be eliminated, for instance, preconcentration of the material can be avoided. Moreover, energy consumption (i.e., primary energy use per ton water removed) for drying oligosaccharides is reduced by 15 to 35% compared to conventional drying techniques such as spray-drying and/or drum/rolling drying known in the art. Also, the capital costs and operational costs are lower compared to the conventional drying techniques by 45 to 65% and 37 to 50%, respectively. This renders agitated thin film drying highly suitable to apply to industrial scale.

In a first aspect, provided is a method for drying an oligosaccharide (or a mixture containing at least 2 oligosaccharides) and/or for obtaining an oligosaccharide (or a mixture containing at least 2 oligosaccharides) in the form of a powder, wherein the oligosaccharide(s) has/have a degree of polymerization (DP) that is lower than 16.

In a second aspect, provided is a method for the production of a purified oligosaccharide (or a mixture containing at least 2 oligosaccharides), wherein the oligosaccharide(s) has/have a degree of polymerization (DP) that is lower than 16.

In a third aspect, provided is a dried powder that is obtainable by a method according to the first and/or second aspect.

In a fourth aspect, provided is a nutritional composition comprising the dried powder according to the third aspect.

In a fifth aspect, provided is a pharmaceutical composition comprising the dried powder according to the third aspect.

In a sixth aspect, provided is the use of the dried powder according to the third aspect for the manufacture of nutritional composition, a food or feed composition, a dietary composition or a cosmetic composition.

In a seventh aspect, provided is the use of the dried powder according to the third aspect for the manufacture of a pharmaceutical composition.

### DETAILED DESCRIPTION

### A Method for Drying an Oligosaccharide

In a first aspect, provided is a method for drying an oligosaccharide and/or for obtaining an oligosaccharide in the form of a solid (preferably a powder), the method comprising the steps of:
i) providing a solution comprising an oligosaccharide; and
ii) applying the solution to an agitated thin film dryer,
wherein the oligosaccharide has a degree of polymerization (DP) that is less than 16, preferably less than 15, even more preferably less than 14, even more preferably less than 13, even more preferably less than 12, even more preferably less than 11, even more preferably less than 10, even more preferably less than 9, even more preferably less than 8, most preferably less than 7. The powder is preferably white to off-white. The term “white to off-white” as used in this disclosure and claims is well-known to the skilled person in the field of regulatory dossiers. Preferably, the term “white to off-white powder” refers to a powder with ICUMSA of ≤1000 units, more preferably ≤900 units, even more preferably ≤800 units, even more preferably ≤700 units, even more preferably ≤600 units, even more preferably ≤500 units, most preferably ≤400 units. The “ICUMSA” refers to the International Commission for Uniform methods of Sugar Analysis, i.e., the unit used for the measurement of sugar color.

In a preferred embodiment, provided is a method for drying an oligosaccharide and/or for obtaining an oligosaccharide in the form of a solid (preferably a powder), the method comprising the steps of:
i) providing a solution comprising an oligosaccharide; and
ii) applying the solution to an agitated thin film dryer to obtain a solid, preferably powder,
wherein the oligosaccharide has a degree of polymerization (DP) that is less than 16, preferably less than 15, even more preferably less than 14, even more preferably less than 13, even more preferably less than 12, even more preferably less than 11, even more preferably less than 10, even more preferably less than 9, even more preferably less than 8, most preferably less than 7. The powder is preferably white to off-white.

### Oligosaccharide

In an embodiment of the first aspect of the disclosure, the solution comprises an oligosaccharide, wherein the oligosaccharide has a degree of polymerization (DP) that is less than 16, preferably less than 15, even more preferably less than 14, even more preferably less than 13, even more preferably less than 12, even more preferably less than 11, even more preferably less than 10, even more preferably less than 9, even more preferably less than 8, most preferably less than 7.

In another embodiment of the disclosure, the solution comprises a mixture of at least 2, preferably at least three, more preferably at least 4, most preferably at least 5, different oligosaccharides, wherein each oligosaccharide has a degree of polymerization that is less than 16, preferably less than 15, even more preferably less than 14, even more preferably less than 13, even more preferably less than 12, even more preferably less than 11, even more preferably less than 10, even more preferably less than 9, even more preferably less than 8, most preferably less than 7. In the context of this disclosure, the term “different oligosaccharides” preferably means “structurally different” or “structurally distinct.”

Preferably, the oligosaccharide or each oligosaccharide of the mixture has a degree of polymerization of at least two, preferably at least three.

In a preferred embodiment of the disclosure, the oligosaccharide or any one, preferably at least two, more preferably at least three, even more preferably at least four, most preferably all, of the oligosaccharides in the mixture is/are a milk oligosaccharide (MO), preferably a mammalian milk oligosaccharide (MMO), more preferably a human milk oligosaccharide (HMO). It is preferred in this context of the invention that the milk oligosaccharide (preferably the MMO, more preferably the HMO) comprises a lactose at its reducing end. In the context of the invention, a “mammalian milk oligosaccharide” (MMO) refers to oligosaccharides such as but not limited to lacto-N-triose II, 3-fucosyllactose, 2′-fucosyllactose, 6-fucosyllactose, 2′,3-difucosyllactose, 2′,2-difucosyllactose, 3,4-difucosyllactose, 6′-sialyllactose, 3′-sialyllactose, 3,6-disialyllactose, 6,6′-disialyllactose, 8,3-disialyllactose, 3,6-disialyllacto-N-tetraose, lactodifucotetraose, lacto-N-tetraose, lacto-N-neotetraose, lacto-N-fucopentaose II, lacto-N-fucopentaose I, lacto-N-fucopentaose III, lacto-N-fucopentaose V, lacto-N-fucopentaose VI, sialyllacto-N-neotetraose d, sialyllacto-N-neotetraose c, sialyllacto-N-tetraose b, sialyllacto-N-tetraose a, lacto-N-difucohexaose I, lacto-N-difucohexaose II, lacto-N-hexaose, lacto-N-neohexaose, para-lacto-N-hexaose, monofucosylmonosialyllacto-N-neotetraose c, monofucosyl para-lacto-N-hexaose, monofucosyllacto-N-hexaose III, isomeric fucosylated lacto-N-hexaose III, isomeric fucosylated lacto-N-hexaose I, sialyllacto-N-hexaose, sialyllacto-N-neohexaose II, difucosyl-para-lacto-N-hexaose, difucosyllacto-N-hexaose, difucosyllacto-N-hexaose a, difucosyllacto-N-hexaose c, fucosylated oligosaccharides, neutral oligosaccharide and/or sialylated oligosaccharides.

Mammalian milk oligosaccharides (MMOs) comprise oligosaccharides present in milk found in any phase during lactation including colostrum milk from humans (i.e., human milk oligosaccharides or HMOs) and mammals including but not limited to cows (Bos Taurus), sheep (Ovis aries), goats (Capra aegagrus hircus), Bactrian camels (Camelus bactrianus), horses (Equusferus caballus), pigs (Sus scropha), dogs (Canis lupus familiaris), ezo brown bears (Ursus arctos yesoensis), polar bear (Ursus maritimus), Japanese black bears (Ursus thibetanus japonicus), striped skunks (Mephitis mephitis), hooded seals (Cystophora cristata), Asian elephants (Elephas maximus), African elephant (Loxodonta africana), giant anteater (Myrmecophaga tridactyla), common bottlenose dolphins (Tursiops truncates), northern minke whales (Balaenoptera acutorostrata), tammar wallabies (Macropus eugenii), red kangaroos (Macropus rufus), common brushtail possum (Trichosurus Vulpecula), koalas (Phascolarctos cinereus), eastern quolls (Dasyurus viverrinus), platypus (Ornithorhynchus anatinus). Human milk oligosaccharides (HMOs) are also known as human identical milk oligosaccharides that are chemically identical to the human milk oligosaccharides found in human breast milk but that are biotechnologically-produced (e.g., using cell free systems or cells and organisms comprising a bacterium, a fungus, a yeast, a plant, animal, or protozoan cell, preferably genetically engineered cells and organisms). Human identical milk oligosaccharides are marketed under the name HiMO.

In an additional and/or alternative preferred embodiment of the disclosure, the oligosaccharide or any one, preferably at least two, more preferably at least three, even more preferably at least four, most preferably all, of the oligosaccharides in the mixture is/are an antigen of the human ABO blood group system. In the context of the invention, an “antigen of the human ABO blood group system” is an oligosaccharide. Such antigens of the human ABO blood group system are not restricted to human structures. The structures involve the A determinant GalNAc-alpha 1,3(Fuc-alpha 1,2)-Gal-, the B determinant Gal-alpha 1,3(Fuc-alpha 1,2)-Gal- and the H determinant Fuc-alpha 1,2-Gal- that are present on disaccharide core structures comprising Gal-beta 1,3-GlcNAc, Gal-beta 1,4-GlcNAc, Gal-beta 1,3-GalNAc and Gal-beta 1,4-Glc.

In an additional and/or alternative preferred embodiment of the disclosure, the oligosaccharide or any one, preferably at least two, more preferably at least three, even more preferably at least four, most preferably all, of the oligosaccharides in the mixture is/are a Lewis-type antigen oligosaccharide. In the context of the invention, a “Lewis-type antigen oligosaccharide” comprises the following oligosaccharides:

H1 antigen, which is Fucα1-2Galβ1-3GlcNAc, or in short 2′FLNB; Lewisa (or Lea), which is the trisaccharide Galβ1-3[Fucα1-4]GlcNAc, or in short 4-FLNB; Lewisb (or Leb), which is the tetrasaccharide Fucα1-2Galβ1-3[Fucα1-4]GlcNAc, or in short DiF-LNB; sialyl Lewisa (or sialyl Lea), which is 5-acetylneuraminyl-(2-3)-galactosyl-(1-3)-(fucopyranosyl-(1-4))-N-acetylglucosamine, or written in short Neu5Acα2-3Galβ1-3[Fucα 1-4]GlcNAc; H2 antigen, which is Fucα1-2Galβ1-4GlcNAc, or otherwise stated 2′fucosyl-N-acetyl-lactosamine, in short 2′FLacNAc; Lewisx (or Lex), which is the trisaccharide Galβ1-4[Fucα1-3]GlcNAc, or otherwise known as 3-Fucosyl-N-acetyl-lactosamine, in short 3-FLacNAc, Lewisy (or Ley), which is the tetrasaccharide Fucα1-2Galβ1-4[Fucα1-3]GlcNAc and sialyl Lewisx (or sialyl Lex), which is 5-acetylneuraminyl-(2-3)-galactosyl-(1-4)-(fucopyranosyl-(1-3))-N-acetylglucosamine, or written in short Neu5Acα2-3Galβ1-4[Fucα1-3]GlcNAc.

In an additional and/or alternative preferred embodiment of the disclosure, the oligosaccharide or any one, preferably at least two, more preferably at least three, even more preferably at least four, most preferably all, of the oligosaccharides in the mixture is/are an animal oligosaccharide, preferably selected from the list consisting of N-glycans and O-glycans. The skilled person will understand that in the context of this disclosure, “N-glycans” and “O-glycans” refer to the oligosaccharide structures as known by the skilled person while the structures are not attached to a protein or peptide.

In an additional and/or alternative preferred embodiment of the disclosure, the oligosaccharide or any one, preferably at least two, more preferably at least three, even more preferably at least four, most preferably all, of the oligosaccharides in the mixture is/are a plant oligosaccharide, preferably selected from the list consisting of N-glycans and O-glycans. The skilled person will understand that in the context of this disclosure, “N-glycans” and “O-glycans” refer to the oligosaccharide structures as known by the skilled person while the structures are not attached to a protein or peptide.

In an additional and/or alternative embodiment of the first aspect of the disclosure, the oligosaccharide or any one, preferably at least two, more preferably at least three, even more preferably at least four, most preferably all, of the oligosaccharides in the solution according to the disclosure is/are isolated from a microbial cultivation or fermentation, cell culture, enzymatic reaction or chemical reaction.

In an additional and/or alternative embodiment of the first aspect of the disclosure, the oligosaccharide or any one, preferably at least two, more preferably at least three, even more preferably at least four, most preferably all, of the oligosaccharides in the mixture according to the invention is obtained from an in vitro and/or ex vivo culture of cells, wherein the cells are preferably chosen from the list consisting of a microorganism, the microorganism is preferably a bacterium, a yeast or a fungus; a plant cell; an animal cell or a protozoan cell.

The latter bacterium preferably belongs to the phylum of the Proteobacteria or the phylum of the Firmicutes or the phylum of the Cyanobacteria or the phylum Deinococcus-Thermus, preferably belongs to the phylum of the Proteobacteria. The latter bacterium belonging to the phylum Proteobacteria belongs preferably to the family Enterobacteriaceae, preferably to the species Escherichia coli. The latter bacterium preferably relates to any strain belonging to the species Escherichia coli such as but not limited to Escherichia coli B, Escherichia coli C, Escherichia coli W, Escherichia coli K12, Escherichia coli Nissle. More specifically, the latter term relates to cultivated Escherichia coli strains—designated as E. coli K12 strains—which are well-adapted to the laboratory environment, and, unlike wild type strains, have lost their ability to thrive in the intestine. Well-known examples of the E. coli K12 strains are K12 Wild type, W3110, MG1655, M182, MC1000, MC1060, MC1061, MC4100, JM101, NZN111 and AA200. Hence, preferably this disclosure specifically relates to a mutated and/or transformed Escherichia coli strain as indicated above wherein the E. coli strain is a K12 strain. More specifically, this disclosure relates to a mutated and/or transformed Escherichia coli strain as indicated above wherein the K12 strain is E. coli MG1655. The latter bacterium belonging to the phylum Firmicutes belongs preferably to the Bacilli, preferably from the species Bacillus, such as Bacillus subtilis or, B. amyloliquefaciens. The latter Bacterium belonging to the phylum Actinobacteria, preferably belonging to the family of the Corynebacteriaceae, with members Corynebacterium glutamicum or C. afermentans, or belonging to the family of the Streptomycetaceae with members Streptomyces griseus or S. fradiae. The latter yeast preferably belongs to the phylum of the Ascomycota or the phylum of the Basidiomycota or the phylum of the Deuteromycota or the phylum of the Zygomycetes. The latter yeast belongs preferably to the genus Saccharomyces (with members like e.g., Saccharomyces cerevisiae, S. bayanus, S. boulardii), Pichia (with members like e.g., Pichia pastoris, P. anomala, P. kuyveri), Komagataella, Hansunella, Kluyveromyces (with members like e.g., Kluyveromyces lactis, K. marxianus, K. thermotolerans), Yarrowia (like e.g., Yarrowia lipolytica), Eremothecium, Zygosaccharomyces, Starmerella (like e.g., Starmerella bombicola) or Debaromyces. The latter yeast is preferably selected from Pichiapastoris, Yarrowia lipolitica, Saccharomyces cerevisiae and Kluyveromyces lactis. The latter fungus belongs preferably to the genus Rhizopus, Dictyostelium, Penicillium, Mucor or Aspergillus. “Plant cells” includes cells of flowering and non-flowering plants, as well as algal cells, for example, Chlamydomonas, Chlorella, etc. Preferably, the plant cell is a tobacco, alfalfa, rice, cotton, rapeseed, tomato, corn, maize or soybean cell. The latter animal cell is preferably derived from non-human mammals (e.g., cattle, buffalo, pig, sheep, mouse, rat), birds (e.g., chicken, duck, ostrich, turkey, pheasant), fish (e.g., swordfish, salmon, tuna, sea bass, trout, catfish), invertebrates (e.g., lobster, crab, shrimp, clams, oyster, mussel, sea urchin), reptiles (e.g., snake, alligator, turtle), amphibians (e.g., frogs) or insects (e.g., fly, nematode) or is a genetically modified cell line derived from human cells excluding embryonic stem cells. Both human and non-human mammalian cells are preferably chosen from the list comprising an epithelial cell like e.g., a mammary epithelial cell, mammary myoepithelial cell, mammary progenitor cell, an embryonic kidney cell (e.g., HEK293 or HEK 293T cell), a fibroblast cell, a COS cell, a Chinese hamster ovary (CHO) cell, a murine myeloma cell like e.g., an N20, SP2/0 or YB2/0 cell, an NIH-3T3 cell, a non-mammary adult stem cell or derivatives thereof such as described in WO21067641, preferably mesenchymal stem cell or derivates thereof as described in WO21067641. The insect cell is preferably derived from Spodoptera frugiperda like e.g., Sf9 or Sf21 cells, Bombyx mori, Mamestra brassicae, Trichoplusia ni like e.g., BTI-TN-5B1-4 cells or Drosophila melanogaster like e.g., Drosophila S2 cells. The latter protozoan cell preferably is a Leishmania tarentolae cell.

In an additional and/or alternative preferred embodiment of the first aspect of the disclosure, the oligosaccharide or any one, preferably at least two, more preferably at least three, even more preferably at least four, most preferably all, of the oligosaccharides in the mixture according to the invention is obtained from an in vitro and/or ex vivo culture of mammary epithelial cells, mammary myoepithelial cells and/or mammary progenitor cells, preferably wherein the cells are generated from non-mammary adult stem cells, more preferably wherein the cells are generated from mesenchymal stem cells. Such cells are well-known to the skilled person, it is in this regard referred to, for example, WO2021/067641 and WO2021/242866 (mammary epithelial cells derived from non-mammary adult stem cells, preferably from mesenchymal stem cells) and WO2021/142241 (mammary epithelial cells, mammary myoepithelial cells, mammary progenitor cells).

In another additional and/or alternative preferred embodiment, the oligosaccharide or any one, preferably at least two, more preferably at least three, even more preferably at least four, most preferably all, of the oligosaccharides in the mixture according to the invention is obtained from an in vitro and/or ex vivo culture of microorganism cells, preferably the microorganism is a bacterium or a yeast, more preferably the microorganism is a bacterium, even more preferably the microorganism is Escherichia coli.

In the context of the disclosure, it is also within the scope of this disclosure that two or more different cells (preferably as defined herein), produce the oligosaccharides of the mixture according to the invention, wherein each cell produces a different oligosaccharide and/or a different mixture of oligosaccharides.

In an additional and/or alternative preferred embodiment of the disclosure, the oligosaccharide or mixture of oligosaccharides is present in the solution in an amount of at least 0.05% (w/v), at least 0.1% (w/v), at least 0.2% (w/v), at least 0.3% (w/v), at least 0.4% (w/v), at least 0.5% (w/v), at least 1.0% (w/v), at least 2.0% (w/v), at least 5.0% (w/v), at least 10% (w/v), at least 15% (w/v), at least 20% (w/v), at least 25% (w/v), at least 30% (w/v), at least 35% (w/v), at least 40% (w/v), at least 45% (w/v), at least 50% (w/v), at least 55% (w/v) or at least 60% (w/v), preferably at least 0.5% (w/v), more preferably at least 1.0% (w/v), even more preferably at least 2.0% (w/v), even more preferably at least 10% (w/v), even more preferably at least 20% (w/v), even more preferably at least 30% (w/v), most preferably at least 40% (w/v).

For solutions that consist essentially of the oligosaccharide or the mixture of oligosaccharides, it is preferred that the oligosaccharide or mixture of oligosaccharides is present in the solution in an amount of at least 1.0% (w/v), at least 2.0% (w/v), at least 5.0% (w/v), at least 10% (w/v), at least 15% (w/v), at least 20% (w/v), at least 25% (w/v), at least 30% (w/v), at least 35% (w/v), at least 40% (w/v), at least 45% (w/v), at least 50% (w/v), at least 55% (w/v) or at least 60% (w/v), preferably at least 10% (w/v), more preferably at least 20% (w/v), even more preferably at least 30% (w/v), most preferably at least 40% (w/v). Different techniques can be used to assess the oligosaccharide % (w/v) within a solution. For example, dissolution of sugar in an aqueous solution changes the refractive index of the solution. Accordingly, an appropriately calibrated refractometer can be used to measure the oligosaccharide % (w/v). Alternatively, the density of a solution may be measured and converted to the oligosaccharide % (w/v). A digital density meter can perform this measurement and conversion automatically, or a hydrometer or pycnometer may be used.

For solutions that further comprise at least one further component as described herein, preferably the component is selected from any one of the list comprising monosaccharide, saccharide, protein, amino acid, vitamin, mineral, fatty acid, fat and/or lipid, the skilled person will readily understand that the amount of the oligosaccharide or the mixture of oligosaccharides in the solution can vary significantly. For example, for infant formulas and the like, HMOs are typically present in the solution in an amount of 0.25 to 2.0% (w/v). For (companion) animal food products, HMOs are typically present in an amount of 0.05% to 0.2% (w/v). For mother milk and for recombinantly produced dairy solutions, oligosaccharides (excluding lactose) are present in an amount of 0.1% to 2.5% (w/v), preferably 0.5% to 2.5% (w/v). In this regard, preferred solutions as provided in the first aspect of the disclosure are the dairy solutions that are recombinantly made as described in WO2021/067641, WO2021/142241 and/or WO2021/242866 (all incorporated by reference). For solutions that further comprise at least one further component as described herein it is preferred that the oligosaccharide or mixture of oligosaccharides is present in the solution in an amount of at least 0.05% (w/v), at least 0.1% (w/v), at least 0.2% (w/v), at least 0.3% (w/v), at least 0.4% (w/v), at least 0.5% (w/v) or at least 1.0% (w/v), preferably at least 0.1% (w/v), more preferably at least 0.5% (w/v) and preferably wherein the amount is ≤5.0% (w/v), preferably ≤3.0% (w/v), more preferably ≤3.0% (w/v).

In an additional and/or alternative preferred embodiment of the disclosure, the oligosaccharide or mixture of oligosaccharides constitute at least 5.0%, at least 10%, at least 20%, at least 30%, at least 40%, at least 50%, at least 60%, at least 70%, at least 80%, at least 85%, at least 90%, at least 95%, at least 97% or at least 98% of the total weight of dry matter within the solution.

For solutions that consist essentially of the oligosaccharide or the mixture of oligosaccharides, it is preferred that the oligosaccharide or mixture of oligosaccharides constitute at least 50%, preferably at least 60%, more preferably at least 70%, even more preferably at least 80%, even more preferably at least 85%, even more preferably at least 90%, even more preferably at least 95%, even more preferably at least 97%, most preferably at least 98%, of the total weight of dry matter within the solution.

For solutions that further comprise at least one further component as described herein, preferably the component is selected from any one of the list comprising monosaccharide, saccharide, protein, amino acid, vitamin, mineral, fatty acid, fat and/or lipid, it is preferred that the oligosaccharide or mixture of oligosaccharides constitute at least 0.1% of the total weight of dry matter, and preferably wherein the oligosaccharide or mixture of oligosaccharides constitute ≤20%, preferably ≤15%, more preferably ≤10%, even more preferably ≤5.0% of the total weight of dry matter. For example, for infant formulas and the like, HMOs typically constitute 2 to 5% of the total weight of dry matter. For (companion) animal food products, HMOs constitute typically 1 to 7%, preferably 3 to 5% of the total weight of dry matter. For mother milk and for recombinantly produced dairy solutions, oligosaccharides (excluding lactose) constitute 0.1 to 20%, preferably 0.1 to 10%, more preferably 0.1 to 5.0%, of the total weight of dry matter. In this regard, preferred solutions as provided in the first aspect of present invention are the dairy solutions that are recombinantly made as described in WO2021/067641, WO2021/142241 and/or WO2021/242866 (all incorporated by reference).

In the context of this disclosure, it is a particularly preferred embodiment that the oligosaccharide or any one, preferably at least two, more preferably at least three, even more preferably at least four, most preferably all, of the oligosaccharides in the mixture, has a solubility of at least 200 g/L, preferably at least 250 g/L, more preferably at least 300 g/L, even more preferably at least 350 g/L, even more preferably at least 400 g/L, even more preferably at least 450 g/L, most preferably at least 500 g/L, in an aqueous solution, preferably in water, and at ambient temperature, preferably at 25° C. In an alternative preferred embodiment in this context of the invention, the oligosaccharide or any one, preferably at least two, more preferably at least three, even more preferably at least four, most preferably all, of the oligosaccharides in the mixture, has a solubility of at least 20%, preferably at least 22.5%, more preferably at least 25%, even more preferably at least 27.5%, even more preferably at least 30%, even more preferably at least 32.5%, even more preferably at least 35%, even more preferably at least 37.5%, even more preferably at least 40%, even more preferably at least 42.5%, even more preferably at least 45%, even more preferably at least 47.5%, most preferably at least 50%, in an aqueous solution, preferably in water, and at ambient temperature, preferably at 25° C., wherein the % solubility is calculated by dividing the mass of the oligosaccharide by the combined mass of the oligosaccharide and solution (e.g., water). Throughout this disclosure and claims, the term “solubility” as understood by the skilled person refers to the maximum amount of an oligosaccharide that can be dissolved in a particular solution at a given temperature. The temperature is preferably the ambient temperature, more preferably 25° C.

### Solution

In an embodiment of the first aspect of the disclosure, the solution comprises an oligosaccharide or a mixture of oligosaccharides as defined herein, wherein the oligosaccharide(s) is/are dissolved in the solution, is/are present as a suspension or is/are present as an emulsion.

In an additional and/or alternative embodiment, the solution comprises water and/or at least one solvent, preferably the solvent is a volatile solvent, more preferably wherein the solvent is selected from any one of acetates, alcohol, chloroform, ether, aliphatic hydrocarbons, aromatic hydrocarbons, chlorinated hydrocarbons and/or ketones. Preferably, the solvent or solvents have a boiling point that is lower than that of water.

In a preferred embodiment, the solution is an aqueous solution. Preferably, the aqueous solution comprises at least 60% w/w water, more preferably at least 70% w/w water, even more preferably at least 80% w/w water, even more preferably at least 90% w/w water, even more preferably at least 95% w/w water, most preferably 100% w/w water.

In an additional and/or alternative preferred embodiment, the solution does not comprise ethanol, preferably the solution does not contain an alcohol, more preferably the solution does not comprise a solvent.

In an additional and/or alternative preferred embodiment of the first aspect of the disclosure, the solution according to the disclosure further comprises at least one component, preferably the component is selected from any one of the list comprising monosaccharide, saccharide, protein, amino acid, vitamin, mineral, fatty acid, fat and/or lipid. The at least one component is dissolved in the solution, is present as a suspension or is present as an emulsion.

Preferably, the solution according to the disclosure does not comprise a polysaccharide.

Preferably, the solution according to the disclosure does not comprise a saccharide with a degree of polymerization of 16 or more.

Preferably, the solution according to the disclosure further comprises at least one protein and/or at least one lipid. In another preferred embodiment the solution is a dairy solution, preferably obtained from an in vitro culture of cells and/or ex vivo culture of cells as defined herein.

In the context of the disclosure, the solution, preferably the dairy solution, preferably comprises 25 wt. % to 90 wt. % (preferably 40 wt. % to 90 wt. %) water, 0.1 wt. % to 20 wt. % (preferably 0.1 wt. % to 15 wt. %, more preferably 3 wt. % to 7 wt. %, even more preferably 1 wt. % to 2 wt. %) of at least one protein, 0 wt. % to 60 wt. % of at least one fat and 0.0005 wt. % to 3 wt. % (preferably 0.1 wt. % to 3 wt. %, more preferably 0.1 wt. % to 1 wt. %) of at least one mineral, optionally 0.1 wt. % to 30 wt. % lactose is present. Further, the solution optionally comprises 0.1 wt. % to 20 wt. %, preferably 0.1 to 15 wt. %, more preferably 0.1 to 10 wt. %, even more preferably 0.1 to 5.0 wt. %, even more preferably 0.1 to 2.5 wt. %, most preferably 0.5 to 2.5 wt. %, of the oligosaccharide or the mixture of at least two oligosaccharides according to the disclosure.

In another embodiment, the solution is an infant formulation that preferably comprises 80 wt. % to 90 wt. % water, 1.0 wt. % to 2.0 wt. % of at least one protein, 2.5 wt. % to 5.0 wt. % of at least one fat, 0.25 wt. % to 0.5 wt. % of at least one mineral, optionally 5 wt. % to 10 wt. % lactose is present. Further, the solution optionally comprises 0.1 wt. % to 2.5 wt. %, preferably 0.1 wt. % to 2.5 wt. %, more preferably 0.5 wt. % to 2.5 wt. %, most preferably 0.5 wt. % to 1.0 wt. %, of the oligosaccharide or the mixture of at least two oligosaccharides according to the disclosure.

In another embodiment, the solution is an animal feed composition that preferably comprises 5 wt. % to 40 wt. % (preferably 15 wt. % to 40 wt. %, more preferably 20 wt. % to 30 wt. %) water, 5.0 wt. % to 40 wt. % of at least one protein, 5.0 wt. % to 45 wt. % of at least one fat, optionally 15 wt. % to 50 wt. % of lactose (and/or glucose) is present. Further, the solution optionally comprises 0.1 wt. % to 10 wt. %, preferably 0.25 wt. % to 10 wt. %, more preferably 0.25 wt. % to 5.0 wt. %, of the oligosaccharide or the mixture of at least two oligosaccharides according to the disclosure. An exemplary animal feed composition is, for example, a companion animal feed or a calf milk replacer composition. The latter, for example, preferably comprises 20 wt. % to 30 wt. % water, 18 wt. % to 24 wt. % of at least one protein, 15 wt. % to 28 wt. % (preferably 20 wt. % to 25 wt. %) of at least one fat, lactose at <50 wt. %, optionally further comprising 0.1 wt. % to 10 wt. %, preferably 0.25 wt. % to 10 wt. %, more preferably 0.25 wt. % to 5.0 wt. %, of the oligosaccharide or the mixture of at least two oligosaccharides according to the disclosure.

In an additional and/or alternative preferred embodiment of the first aspect of the disclosure, the solution according to the disclosure is obtained from an in vitro and/or ex vivo culture of cells, wherein the cells are preferably as defined earlier herein.

In an additional and/or alternative preferred embodiment of the first aspect of the disclosure, the solution according to the disclosure is obtained from an in vitro and/or ex vivo culture of mammary epithelial cells, mammary myoepithelial cells and/or mammary progenitor cells, preferably wherein the cells are generated from non-mammary adult stem cells, more preferably wherein the cells are generated from mesenchymal stem cells. Such cells are well-known to the skilled person, it is in this regard referred to, for example, WO2021/067641 and WO2021/242866 (mammary epithelial cells derived from non-mammary adult stem cells, preferably from mesenchymal stem cells) and WO2021/142241 (mammary epithelial cells, mammary myoepithelial cells, mammary progenitor cells).

In an additional and/or alternative preferred embodiment of the first aspect of the disclosure, the solution has a pH ranging from 4.0 to and including 7.0, preferably ranging from 4.0 to and including 6.0, more preferably ranging from 4.0 to and including 5.0. This advantageously reduces or prevents the isomerization of the oligosaccharide and/or mixture of oligosaccharides according to the disclosure.

In an additional and/or alternative preferred embodiment of the first aspect of the disclosure, the solution has a dry matter content of at least 2.0 wt. %, preferably at least 5.0 wt. %, even more preferably at least 10 wt. %, even more preferably at least 20 wt. %, even more preferably at least 30 wt. %, even more preferably at least 40 wt. %, most preferably at least 50 wt. %. In an additional and/or alternative embodiment, the solution has a dry matter content that is not higher than or that is lower than 95 wt. %, preferably 90 wt. %, even more preferably 85 wt. %, most preferably 80 wt. %.

In an additional and/or alternative preferred embodiment of the first aspect of the disclosure, the solution is obtained by mixing a first solution and at least a second solution, preferably wherein the at least a second solution is as a solution according to the disclosure as defined herein.

Preferably, the solutions differ in composition, more preferably wherein the solutions differ in the quantity and/or quality of at least one component selected from any one of the lists comprising monosaccharide, saccharide, protein, amino acid, vitamin, mineral, fatty acid, fat and/or lipid.

In a more preferred embodiment of the first aspect of the disclosure, the solution does not comprise a polysaccharide. In an additional and/or alternative more preferred embodiment, the solution does not comprise a fat. In an additional and/or alternative more preferred embodiment, the solution does not comprise a lipid.

In an even more preferred embodiment of the first aspect of the disclosure, the solution is not a food composition, a feed composition or a dietary composition.

### Obtained Powder

In an embodiment of the first aspect of the disclosure, the powder obtained by a method according to the first aspect of the disclosure is preferably as described in the third aspect of this disclosure.

### Dryer

In an embodiment of the first aspect of the disclosure the solution according to the disclosure is applied to an agitated thin film dryer, preferably to obtain a solid, more preferably to obtain a powder. Agitated thin film dryers are known in the art and essentially consist of two major elements, a cylindrical drying chamber with a heating jacket, and a rotor with fixed blades. The liquid feed is applied to the inside of the chamber (which is heated from the outside) where the rotating blades agitate the liquid feed, resulting in a thin film on the inside of the chamber (the blades are either configured as small-gap or as scraped surface blades as known in the art). The liquid feed will transform into a viscous liquid, then into a paste and subsequently into a solid that is removed (i.e., scraped) from the chamber by the action of the blades. In the context of the disclosure, it is preferred that the blades of the agitated thin film dryer scrape the formed solid/powder from the inside of the chamber.

An agitated thin film dryer in the context of this disclosure, is hence essentially different from a static (thin film) evaporator such as a falling film evaporator, a forced circulation evaporator, a natural circulation evaporator, a rising or climbing evaporator or a Whitlock evaporator. The agitated thin film dryer is also essentially different from a dryer wherein the heat comes into direct contact with the liquid feed as is the case with a spray dryer, for example. Further, the agitated thin film dryer is also essentially different from other dryers based on indirect heating such as, for example, a paddle heater (wherein paddles stir the liquid feed and hence do not form a thin film as is the case with an agitated thin film dryer) or a drum/roller dryer. In the latter case, the liquid feed is applied on the underside or top of the drum/roller, while the drum is heated from the inside. A scraper removes solids formed on the drum.

In a preferred embodiment, the agitated thin film dryer is configured for drying the solution according to the disclosure, preferably to obtain a solid, more preferably to obtain a powder. In the context of the disclosure, it follows that evaporators such as, for example, a short path evaporator (consisting of built-in condenser in contrast to an agitated thin film dryer that has no condenser inside as it is externally connected to the vapor phase outlet of the dryer) and a wiped film evaporator (configured for evaporation but not suitable for drying). A wiped film evaporator, as known by the skilled person, only exists in vertical orientation and comprises several cylindrical heating jackets. Wiper blades trigger (rotating at higher centrifugal force) the formation of bow waves of highly turbulent areas with intense heat and mass transport.

In an additional and/or alternative preferred embodiment, the agitated thin film dryer is configured for agitated thin film drying of the solution according to the disclosure.

In a more preferred embodiment, the agitated thin film dryer is a vertical thin film dryer, a horizontal thin film dryer or a combi thin film dryer, more preferably the agitated thin film dryer is a vertical thin film dryer or a horizontal thin film dryer, most preferably the agitated thin film dryer is a vertical thin film dryer.

A vertical thin film dryer, as known in the art, consists of a cylindrical, vertically arranged body with heating jacket and a rotor inside. The rotor is equipped with rows of pendulum blades all over the length of the dryer. The hinged blades spread the wet feed product in a thin product layer over the heated wall and mix the product layer material intensively. Therefore, the volatile components evaporate continuously from the product layer with high evaporation rates. The hinged blades are designed with a minimum gap to prevent fouling of the heating surface by product, but are never in contact with the heated wall. The product enters the dryer at its top. The evaporation starts after heating to the boiling point. In the slurry zone first solids are formed and with advancing evaporation of the volatiles and continued shearing by the hinged blades the paste breaks up to powder. The final solid product is discharged by gravity at the bottom of the dryer via a suitable air lock. Moisture levels of less than 1% can be achieved. The residence time of the product is typically between 30 and 60 seconds for industrial-scale dryers.

A horizontal thin film dryer, as known in the art, consists of a horizontally arranged heated shell with end covers and a rotor with bolted-on blades. The wet product fed through the inlet nozzle is picked up by the rotor blades, applied on the hot wall and simultaneously conveyed toward the outlet nozzle at the opposite end of the body. The generated vapors are streaming counter-currently to the product flow and are leaving the dryer close to the feed nozzle. Evaporating and conveying capacity are adapted by the right rotor blade arrangement. Entrained particles from the dry zone are removed in the wet zone. Moisture levels of less than 1% can be achieved. The residence time of the product is typically between 5 and 15 minutes for industrial-scale dryers.

A combi-dryer, as known in the art, consists of a combination of a vertical thin film dryer and a horizontal thin film dryer. The wet product is fed into the vertical thin film dryer directly above the heating zone and evenly spread as thin, turbulent film on the heat exchange surface by the high-speed rotor. The pre-dried product falls directly onto the rotor of the horizontal thin film dryer. This rotor conveys the product in horizontal direction to the product outlet on the opposite side of the dryer.

In an additional and/or alternative more preferred embodiment, the (thin) film dryer is operated semi-batch wise or continuously, preferably continuously.

In an additional and/or alternative preferred embodiment, the temperature of the heated surface of the agitated thin film dryer is at least 10° C.; preferably at least 15° C., more preferably at least 20° C., even more preferably at least 25° C., even more preferably at least 30° C., even more preferably at least 35° C., even more preferably at least 40° C., even more preferably at least 45° C., even more preferably at least 50° C., even more preferably at least 55° C., even more preferably at least 60° C., most preferably at least 50° C.

In an additional and/or alternative preferred embodiment, the temperature of the heated surface of the (thin) film dryer is ≤150° C., preferably ≤140° C., more preferably ≤130° C., even more preferably ≤120° C., even more preferably ≤110° C., even more preferably ≤100° C., even more preferably ≤90° C., even more preferably ≤80° C., even more preferably ≤75° C., most preferably ≤70° C.

In an additional and/or alternative preferred embodiment, the temperature of the heated surface of the agitated thin film dryer ranges from 15° C. to 140° C., preferably from 25° C. to 140° C., more preferably from 25° C. to 125° C., even more preferably from 25° C. to 110° C., even more preferably from 25° C. to 90° c., even more preferably from 30° C. to 90° C., even more preferably from 30° C. to 80° C., even more preferably from 30° C. to 70° C., even more preferably from 40° C. to 90° C., even more preferably from 40° C. to 80° C., even more preferably from 40° C. to 70° C., even more preferably from 50° C. to 90° C., even more preferably from 50° C. to 80° C., even more preferably 50° C. to 75° C., most preferably from 50° C. to 70° C. For the sake of clarity, the expressions “x to y” and “x-y” as used throughout this disclosure and claims includes x, y and each value in between.

In an additional and/or alternative preferred embodiment, the temperature of the heated surface of the agitated thin film dryer ranges from 15° C. to 70° C., preferably from 15° C. to 60° C., more preferably from 15° C. to 50° C., even more preferably from 15° C. to 40° C., most preferably from 20° C. to 40° C.

In an additional and/or alternative preferred embodiment, the temperature of the heated surface of the agitated thin film dryer is above the boiling point of the solution, preferably above the boiling point of water; wherein the boiling point is at the drying pressure (i.e., the pressure within the drying chamber and hence the pressure at which the solution of the disclosure is dried). Preferably, the temperature is 10° C. to 30° C., preferably 10° C. to 20° C. higher than the boiling point.

In an additional and/or alternative preferred embodiment, the solution according to the disclosure is dried at a temperature that is at least 10° C.; preferably at least 15° C., more preferably at least 20° C., even more preferably at least 25° C., even more preferably at least 30° C., even more preferably at least 35° C., even more preferably at least 40° C., even more preferably at least 45° C., even more preferably at least 50° C., even more preferably at least 55° C., even more preferably at least 60° C., most preferably at least 50° C. In an additional and/or alternative preferred embodiment, the solution according to the disclosure is dried at a temperature that is ≤150° C., preferably ≤140° C., more preferably ≤130° C., even more preferably ≤120° C., even more preferably ≤110° C., even more preferably ≤100° C., even more preferably ≤90° C., even more preferably ≤80° C., even more preferably ≤75° C., most preferably ≤70° C.

In an additional and/or alternative preferred embodiment, the solution according to the disclosure is dried at a temperature that ranges from 15° C. to 140° C., preferably from 25° C. to 140° C., more preferably from 25° C. to 125° C., even more preferably from 25° C. to 110° C., even more preferably from 25° C. to 90° c., even more preferably from 30° C. to 90° C., even more preferably from 30° C. to 80° C., even more preferably from 30° C. to 70° C., even more preferably from 40° C. to 90° C., even more preferably from 40° C. to 80° C., even more preferably from 40° C. to 70° C., even more preferably from 50° C. to 90° C., even more preferably from 50° C. to 80° C., even more preferably 50° C. to 75° C., most preferably from 50° C. to 70° C.

In an additional and/or alternative preferred embodiment, the solution according to the disclosure is dried at a temperature that ranges from 15° C. to 70° C., preferably from 15° C. to 60° C., more preferably from 15° C. to 50° C., even more preferably from 15° C. to 40° C., most preferably from 20° C. to 40° C.

In an additional and/or alternative preferred embodiment, the solution according to the disclosure is dried at a temperature above the boiling point of the solution, preferably above the boiling point of water; wherein the boiling point is at the drying pressure (i.e., the pressure within the drying chambre and hence the pressure at which the solution of the disclosure is dried). Preferably, the temperature is 10° C. to 30° C., preferably 10° C. to 20° C. higher than the boiling point.

In an additional and/or alternative preferred embodiment, the solution according to the disclosure is dried under atmospheric pressure or under vacuum, preferably under vacuum. Preferably, the solution is dried at a pressure of ≤1013 mbar, preferably ≤550 mbar, more preferably ≤250 mbar, even more preferably ≤100 mbar, even more preferably ≤50 mbar, even more preferably ≤40 mbar, even more preferably ≤25 mbar, even more preferably ≤10 mbar, even more preferably ≤1 mbar.

It is hence a preferred embodiment of the disclosure, that the solution is dried at a pressure of 1.0-150 mbar, preferably 1.0-100 mbar, more preferably 1.0-50 mbar, even more preferably 1.0-40 mbar, even more preferably 1.0-25 mbar, even more preferably 1.0-10 mbar, even more preferably 1.0-50 mbar, most preferably 10-50 mbar. In a more preferred embodiment, the solution is dried at a pressure of 5-150 mbar, preferably 5-100 mbar, more preferably 5-50 mbar, even more preferably 5-40 mbar. In an even more preferred embodiment, the solution is dried at a pressure of 10-150 mbar, preferably 10-100 mbar, more preferably 10-50 mbar, even more preferably 10-40 mbar.

In an additional and/or alternative preferred embodiment, the solution according to the disclosure is applied such that it forms a film on the heated surface of the (thin) film dryer, wherein the height of the film is (i) at least 0.01 mm, preferably at least 0.05 mm, more preferably at least 0.1 mm, even more preferably at least 0.2 mm, even more preferably at least 0.3 mm, even more preferably at least 0.4 mm, most preferably at least 0.5 mm, and/or (ii)≤20 mm, preferably ≤15 mm, more preferably ≤10 mm, even more preferably ≤5 mm, even more preferably ≤2 mm, most preferably ≤1 mm.

In an additional and/or alternative preferred embodiment, the solution according to the disclosure is applied to the agitated thin film dryer at a rate of at least 2.0 kg per hour per m², preferably at least 2.5 kg per hour per m², more preferably at least 3.0 kg per hour per m², more preferably at least 5.0 kg per hour per m², even more preferably at least 10.0 kg per hour per m², even more preferably at least 20.0 kg per hour per m². Preferably, the solution according to the disclosure is applied to the agitated thin film dryer at a rate of ≤200 kg per hour per m², more preferably ≤100 kg per hour per m², even more preferably ≤75 kg per hour per m², even more preferably ≤50 kg per hour per m², even more preferably ≤30 kg per hour per m². In the context of the disclosure, the m² refers to the heat exchange area of the dryer.

In an additional and/or alternative preferred embodiment of the disclosure, the solution, according to the disclosure, is applied to the agitated thin film dryer at a feeding rate (kg per hour per m²) that is at least, preferably is, the feeding rate that is required to obtain a thin film on at least 70%, preferably at least 80%, more preferably at least 85%, even more preferably at least 90%, even more preferably at least 95%, most preferably the complete, of the heat exchange area of the dryer.

In the context of the disclosure, the term “kg per hour per m²” and “liter per hour per m²” can be interchangeably used.

In an additional and/or alternative preferred embodiment, the blades of the agitated thin film dryer rotate with a speed that is equal or higher to the speed that results in the formation of a thin film (at the inner side of the chamber of the dryer) as defined herein. Preferably, blades of the agitated thin film dryer rotate with a speed that is equal or higher to the speed that is required to obtain a thin film as defined herein on at least 70%, preferably at least 80%, more preferably at least 85%, even more preferably at least 90%, even more preferably at least 95%, most preferably the complete, of the heat exchange area of the dryer.

It is hence a preferred embodiment of the disclosure that the blades of the agitated thin film dryer rotate with a speed of 10 to 2500 rpm (i.e., rounds per minute), preferably 10 to 2000 rpm, more preferably 10 to 1500, even more preferably 10 to 1000, even more preferably 10 to 750 rpm, even more preferably 10 to 600 rpm, even more preferably 10 to 500 rpm, even more preferably 25 to 500 rpm, even more preferably 10 to 250 rpm, most preferably 25 to 250 rpm, to agitate the solution applied to the agitated thin film dryer, resulting in a thin film on the inside of the chamber of the dryer.

It is hence a more preferred embodiment of the disclosure that the blades of the agitated thin film dryer rotate with a speed of 200 to 1500 rpm, preferably 200 to 1250 rpm, more preferably 500 to 1250 rpm, most preferably 500-1000 rpm.

### A Method for the Production of a Purified Oligosaccharide

In a second aspect, provided is a method for the production of a purified oligosaccharide or a mixture of at least two oligosaccharides, the method comprising the steps of:
(a) cultivating at least one cell, preferably a single cell, that is capable of producing an oligosaccharide or a mixture of at least two oligosaccharides in a suitable cultivation medium to form a cultivation broth, preferably wherein the cell is metabolically engineered for the production of the oligosaccharide or the mixture;
(b) purifying the oligosaccharide or the mixture from the cultivation broth by:
   (i) clarifying the cultivation broth, and
   (ii) removing salts and/or medium components form the clarified cultivation broth, and/or
   (iii) concentrating the oligosaccharide or the mixture in the clarified cultivation broth,
   thereby providing a solution comprising a purified oligosaccharide or a purified mixture of at least 2 different oligosaccharides; and
(c) drying the solution by a method according to the first aspect of the disclosure,
wherein the oligosaccharide and the mixture of at least two oligosaccharides are as described in the first aspect of the disclosure.

In other words, the second aspect of provided is a method for drying an oligosaccharide and/or for obtaining an oligosaccharide in the form of a solid as described in the first aspect of the disclosure, wherein the solution is obtained by a method comprising the steps of:
(a) cultivating at least one cell, preferably a single cell, that is capable of producing the oligosaccharide or the mixture of at least two oligosaccharides in a suitable cultivation medium to form a cultivation broth, preferably wherein the cell is metabolically engineered for the production of the oligosaccharide or the mixture; and
(b) purifying the oligosaccharide or the mixture from the cultivation broth by:
   (i) clarifying the cultivation broth, and
   (ii) removing salts and/or medium components form the clarified cultivation broth, and/or
   (iii) concentrating the oligosaccharide or the mixture in the clarified cultivation broth,
thereby providing a solution comprising a purified oligosaccharide or a purified mixture of at least 2 different oligosaccharides.

The purification comprises a combination of clarification of the cultivation broth and removing salts and/or medium components from the clarified cultivation broth and/or concentrating the oligosaccharide or the oligosaccharide mixture in the clarified cultivation broth thereby providing a solution comprising the purified oligosaccharide or mixture of oligosaccharides. In an embodiment, the clarification is combined with the removal of salts and/or medium components. In an embodiment, the clarification is combined with the step of concentrating the oligosaccharide or oligosaccharide mixture in the clarified cultivation. In an embodiment, the clarification is combined with the removal of salts and/or medium components and further combined with the step of concentrating the oligosaccharide or oligosaccharide mixture resulting from the step of removal of salts and/or medium components. In an embodiment, the clarification is combined with the step of concentrating the oligosaccharide or oligosaccharide mixture and further combined with the removal of salts and/or medium components of the oligosaccharide or oligosaccharide mixture resulting from the step of concentrating. Advantageously, the oligosaccharide or the mixture of oligosaccharides is obtained in large quantities and at high purity.

The method of this disclosure allows efficient purification of large quantities of a mix of oligosaccharides at high purity.

In a preferred embodiment of the second aspect of the disclosure, step (iii) comes before step (ii).

In another preferred embodiment, the method further comprises decolorization.

In an additional and/or alternative embodiment, the method further comprises a step of sterile filtration and/or endotoxin removal, preferably by filtration of the purified oligosaccharide mixture through a 3 kDa filter.

### Step (a)

In an embodiment of the second aspect of the disclosure, the at least one cell is cultured in a minimal salt medium with a carbon source on which the at least one cell grows. Preferably, the minimal salt medium contains sulphate, phosphate, chloride, ammonium, calcium ion, magnesium ion, sodium ion, potassium ion, iron ion, copper ion, zinc ion, manganese ion, cobalt ion, and/or selenium ion.

In an additional and/or alternative embodiment, the at least one cell according to the disclosure grows on a monosaccharide, disaccharide, oligosaccharide, polysaccharide, polyol, a complex medium or a mixture thereof as the main carbon source. With the term “main” is meant the most important carbon source for the bioproducts of interest, biomass formation, carbon dioxide and/or by-products formation (such as acids and/or alcohols, such as acetate, lactate, and/or ethanol), i.e., 20.0%, 25.0%, 30.0%, 35.0%, 40.0%, 45.0%, 50.0%, 55.0%, 60.0%, 65.0%, 70.0%, 75.0%, 80.0%, 81.0%, 82.0%, 83.0%, 84.0%, 85.0%, 86.0%, 87.0%, 88.0%, 89.0%, 90.0%, 91.0%, 92.0%, 93.0%, 94.0%, 95.0%, 95.5%, 96.0%, 96.5%, 97.0%, 97.5%, 98.0%, 98.5%, 99.0%, 99.5%, 100% of all the required carbon is derived from the above-indicated carbon source. In a preferred embodiment of the disclosure, the carbon source is the sole carbon source for the organism, i.e., 100% of all the required carbon is derived from the above-indicated carbon source. Common main carbon sources comprise but are not limited to glucose, glycerol, fructose, maltose, lactose, arabinose, malto-oligosaccharides, maltotriose, sorbitol, xylose, rhamnose, sucrose, galactose, mannose, methanol, ethanol, trehalose, starch, cellulose, hemi-cellulose, corn-steep liquor, high-fructose syrup, acetate, citrate, lactate and pyruvate. With the term “complex medium” is meant a medium for which the exact constitution is not determined. Examples are molasses, corn steep liquor, peptone, tryptone or yeast extract.

In an additional and/or alternative embodiment, the carbon source comprises one or more of glucose, fructose, mannose, sucrose, maltose, corn steep liquor, lactose, galactose, high fructose syrup, starch, cellulose, hemi-cellulose, malto-oligosaccharides, trehalose, glycerol, acetate, citrate, lactate and pyruvate.

### Step (b)

In an embodiment of the second aspect of the disclosure, the purification involves clarifying (i.e., step (i)) the oligosaccharide or oligosaccharide mixture containing cultivation broth to remove suspended particulates and contaminants, particularly cells, cell components, insoluble metabolites and debris produced by culturing the cell. In this step, the cultivation broth containing the produced oligosaccharide or oligosaccharide mixture can be clarified in a conventional manner. Preferably, clarification is done by centrifugation, flocculation, decantation, ultrafiltration and/or filtration. In another embodiment, the step (i) of clarifying the cultivation broth comprises one or more of clarification, clearing, filtration, microfiltration, centrifugation, decantation and ultrafiltration, preferably the step (i) further comprising use of a filter aid and/or flocculant. In an additional and/or alternative preferred embodiment, step (i) comprises subjecting the cultivation broth to two membrane filtration steps using different membranes. In an additional and/or alternative preferred embodiment, step (i) of clarifying the cultivation broth further comprises use of a filtration aid, preferably an adsorbing agent, more preferably active carbon.

In an additional and/or alternative embodiment, step (i) comprises a first step of clarification by microfiltration. Alternatively, step (i) comprises a first step of clarification by centrifugation. Alternatively, step (i) comprises a first step of clarification by flocculation. Alternatively, step (i) comprises a first step of clarification by ultrafiltration.

In a preferred embodiment, step (i) comprises ultrafiltration. Preferably, the ultrafiltration in step (i) has a molecular weight cut-off equal to or higher than 1 kDa, 2 kDa, 3 kDa, 4 kDa, 5 kDa, 6 kDa, 7 kDa, 8 kDa, 9 kDa, 10 kDa, 11 kDa, 12 kDa, 13 kDa, 14 kDa, 15 kDa. Alternatively or preferably, step (i) comprises two consecutive ultrafiltrations, and wherein the membrane molecular weight cut-off of the first ultrafiltration is higher than that of the second ultrafiltration.

In another preferred embodiment, step (i) is preceded by an enzymatic treatment. Preferably, the enzymatic treatment comprises incubation of the cultivation or fermentation broth with one or more enzymes selected from the group consisting of: glycosidase, lactase, b-galactosidase, fucosidase, sialidase, maltase, amylase, hexaminidase, glucuronidase, trehalase, and invertase. Preferably or alternatively, the enzymatic treatment converts lactose and/or sucrose to monosaccharides.

Another step (i.e., step (ii)) of purifying the oligosaccharide or the mixture from the cultivation broth preferably involves removing salts and/or medium components, comprising proteins, as well as peptides, amino acids, RNA and DNA and any endotoxins and glycolipids that could influence purity, from the cultivation broth containing the oligosaccharide or oligosaccharide mixture, after it has been clarified. In this step, proteins, salts, by-products, color and other related impurities are removed from the oligosaccharide or oligosaccharide mixture containing mixture by ultrafiltration, nanofiltration, reverse osmosis, microfiltration, activated charcoal or carbon treatment, tangential flow high-performance filtration, tangential flow ultrafiltration, affinity chromatography, ion exchange (such as but not limited to cation exchange, anion exchange, mixed bed ion exchange), hydrophobic interaction chromatography and/or gel filtration (i.e., size exclusion chromatography), particularly by chromatography, more particularly by ion exchange chromatography or hydrophobic interaction chromatography or ligand exchange chromatography. With the exception of size exclusion chromatography, proteins and related impurities are retained by a chromatography medium or a selected membrane, while the oligosaccharide or oligosaccharide mixture remains in the mixture.

In an embodiment, step (ii) of removing salts and/or medium components from the clarified cultivation broth comprises at least one or more of nanofiltration, dialysis, electrodialysis, use of activated charcoal or carbon, use of charcoal, tangential flow high-performance filtration, tangential flow ultrafiltration, affinity chromatography, ion exchange, ion exchange chromatography, hydrophobic interaction chromatography, gel filtration, ligand exchange chromatography, column chromatography, cation exchange adsorbent resin, and use of ion exchange resin. Preferably, step (ii) of removing salts and/or medium components from the clarified cultivation or fermentation broth by ion exchange is any one or more of cation exchange, anion exchange, mixed bed ion exchange, simulated moving bed chromatography.

In an embodiment, step (ii) of removing salts and/or medium components from the clarified cultivation broth comprises anion exchange wherein the anion exchange resin has a moisture content of 30-48% and preferably is a gel type anion exchanger. Such anion exchanger is preferably selected from the group comprising Dowex 1-X8, XA4023, XA3112, DIAION SA20A, DIAION SA10A, preferably in OH− form. Such anion exchange treatment is very performant for oligosaccharide mixture solution purification wherein the oligosaccharide mixture comprises charged oligosaccharide, especially sialylated oligosaccharides such as sialyllactose. As such, such anion exchange resin can be used in a pure anion exchange step combined with a cation exchange step or used in a mixed bed ion exchange setting.

In an embodiment, step (ii) comprises a step of cation exchange combined with a step of anion exchange wherein the anion exchange resin has a moisture content of 30-48% and preferably is a gel type anion exchanger, preferably as described herein. In an embodiment, the step of cation exchange precedes the step of anion exchange.

The anion exchange resin, characterized by the moisture content of 30-48 percent, is preferably a gel type anion exchanger that desalts the clarified cultivation or fermentation broth, though without thereby binding the charged, e.g., sialyl, group containing oligosaccharides and, in particular, the sialyllactose, which oligosaccharides are also present in salt form. In other words, this involves an anion exchange resin that has selectivity for negatively charged minerals, but not for sialyllactose. As described in the art, see e.g., WO2009/113861, to this end, it is necessary that the moisture content, that is, the water content, is not greater than 48%, and preferably not greater than 45%. At moisture contents lower than 35%, and more so at moisture contents lower than 30%, the desalting capacity starts to become too low to yield an effective process. The moisture content in the anion exchanger is determined in the following manner: prior to measurement of the moisture content of the resin, adhering water is removed, for instance, by wrapping the resin in a cloth and then subjecting it to centrifugation (centrifuge: 30 cm diameter; 3,000 rpm); the resin is then weighed, for instance, in a weighing bottle; after which the resin is dried for 4 hours at a constant temperature of 105° C.; the resin is then cooled down in an exicator for 30 minutes; after which in turn the weight of the dry resin is determined; the moisture percentage (weight percent)=[(weight loss after drying (g))/(weight of the wet resin)]*100 percent. Through this desalting, an important part of the negatively charged ions is removed without substantial amounts of sialyllactose (despite the negative charge) being thereby removed.

The anion exchange resin mentioned is preferably and usually in the free base form (hydroxide form) because this results in a greatest possible desalting capacity. Suitable anion exchange resins are strongly cross-linked polystyrene-divinylbenzene gels, such as Diaion SA20A, Diaion WA20A.

In an embodiment, step (ii) comprises a treatment with a mixed bed ion exchange resin. In an embodiment, such mixed bed ion exchange resin is a mixed bed column of Diaion SA20A and Amberlite FPC 22H mixed in a ratio 1,1:1 to 1,9:1. In an embodiment, such mixed bed ion exchange resin comprises an anion exchange resin having a moisture content of 30-48% and preferably being microporous or a gel type anion exchanger. As explained above, such anion exchange type is very useful in the purification of solutions comprising charged oligosaccharide.

In an additional and/or alternative embodiment, step (ii) comprises nanofiltration and/or electrodialysis. Preferably, the nanofiltration and/or electrodialysis is performed twice. More preferably, the nanofiltration and/or electrodialysis steps are performed consecutively. In some embodiments, the ultrafiltration permeate of step (i) is nanofiltered and/or electrodialyzed in step (ii).

In an embodiment, the cationic ion exchanger treatment is a strongly acidic cation exchanger treatment, preferably treatment with a strong cation exchange resin in H+ form, K+ or Na+ form.

In some embodiments, step (i) is ultrafiltration, and step (ii) is nanofiltration and/or electrodialysis treatment combined with treatment with an ion exchange resin and/or chromatography. Preferably, the ion exchange resin is a strongly acidic cation exchange resin and/or a weakly basic anion exchange resin. More preferably, the ion exchange resin is a strongly acidic cation exchange resin and a weakly basic anion exchange resin.

In still another preferred embodiment of the method of the disclosure, step (ii) comprises treatment with a strong cation exchange resin in H+− form and a weak anion exchange resin in free base form, preferably in Cl− form, alternatively preferably in OH− form. Preferably, the treatment with a strong cation exchange resin in H+− form is directly followed by a treatment with a weak anion exchange resin in free base form.

In a preferred embodiment of the method of the disclosure, the method does not comprise electrodialysis. In some embodiments the method does comprise electrodialysis.

In an embodiment of the disclosure wherein the step (i) is ultrafiltration, the step (ii) is nanofiltration and/or electrodialysis treatment combined with treatment with an ion exchange resin being strongly acidic cation exchange resin and/or a weakly basic anion exchange resin, the treatment with a strong cation exchange resin and/or a weak anion exchange resin is preceded by ultrafiltration followed by nanofiltration and/or electrodialysis.

Another step (i.e., step (iii)) of purifying the oligosaccharide or the mixture from the cultivation broth preferably involves concentrating the cultivation broth containing the oligosaccharide or oligosaccharide mixture. In an embodiment, the third step precedes the second step. In an embodiment, the step of concentrating precedes the second step and is once more applied after the second step as described above.

In an embodiment, step (iii) of concentrating comprises one or more of nanofiltration, diafiltration, reverse osmosis, evaporation, wiped film evaporation, and falling film evaporation.

In another embodiment, the purified oligosaccharide or oligosaccharide mixture is concentrated to a syrup of at least 40% dry matter.

### Cells

In an embodiment of the second aspect of the disclosure, the at least one cell is a cell as described in the first aspect of the disclosure.

In the context of the disclosure, it is also encompassed to cultivate two or more different cells, each cell producing a different oligosaccharide and/or a different mixture of oligosaccharides. Hence, in an additional and/or alternative embodiment, the mixture of at least 2 oligosaccharides is obtained by culturing (i) a single cell, preferably the single cell is metabolically engineered for the production of the oligosaccharide or the mixture, or (ii) at least two different cells, preferably wherein each different cell is metabolically engineered for the production of a different oligosaccharide or different mixture of oligosaccharides.

### Dried Powder

In a third aspect, provided is a dried powder that is obtainable by a method according to the first and/or second aspect of the disclosure. In a preferred embodiment, the powder is white to off-white.

In a preferred embodiment of the third aspect of the disclosure, the dried powder contains at least 70 wt. %, preferably at least 80 wt. %, more preferably at least 85 wt. %, even more preferably at least 90 wt. %, even more preferably at least 93 wt. %, even more preferably at least 95 wt. %, even more preferably at least 97 wt. %, most preferably at least 98 wt. %, of dry matter.

In an additional and/or alternative preferred embodiment of the disclosure, the oligosaccharide or mixture of oligosaccharides constitute at least 5.0%, at least 10%, at least 20%, at least 30%, at least 40%, at least 50%, at least 60%, at least 70%, at least 80%, at least 85%, at least 90%, at least 95%, at least 97% or at least 98% of the total weight of dry matter within the dried powder.

For dried powder obtained from solutions that consist essentially of the oligosaccharide or the mixture of oligosaccharides, it is preferred that the oligosaccharide or mixture of oligosaccharides constitute at least 50%, preferably at least 60%, more preferably at least 70%, even more preferably at least 80%, even more preferably at least 85%, even more preferably at least 90%, even more preferably at least 95%, even more preferably at least 97%, most preferably at least 98%, of the total weight of dry matter within the dried powder.

For dried powder obtained from solutions that further comprise at least one further component as described herein, preferably the component is selected from any one of the list comprising monosaccharide, saccharide, protein, amino acid, vitamin, mineral, fatty acid, fat and/or lipid, it is preferred that the oligosaccharide or mixture of oligosaccharides constitute at least 0.1% of the total weight of dry matter, and preferably wherein the oligosaccharide or mixture of oligosaccharides constitute ≤20%, preferably ≤15%, more preferably ≤10%, even more preferably ≤5.0% of the total weight of dry matter within the powder.

In an additional and/or alternative preferred embodiment of the third aspect of the disclosure, the obtained powder contains ≤15 wt. %, preferably ≤10 wt. %, more preferably ≤9 wt. %, more preferably ≤8 wt. %, more preferably ≤7 wt. %, even more preferably ≤5 wt. %, even more preferably ≤4 wt. % of liquid, even more preferably ≤3 wt. % of liquid, even more preferably ≤2 wt. % of liquid, most preferably ≤1 wt. %, preferably wherein the liquid is water. To achieve a very low level of liquid in the obtained powder, a horizontal thin film dryer can be advantageously used as the residence time within the drying chamber is typically a multitude of that compared to a vertical thin film dryer.

In an additional and/or alternative preferred embodiment of the third aspect of the disclosure, the obtained powder has a median diameter (D50) that is larger than what is typically obtained with spray drying of the solution according to the disclosure. In the context of this disclosure, the particle size is preferably assessed by laser diffraction. The system detects scattered and diffracted light by an array of concentrically arranged sensor elements. The software-algorithm is then approximating the particle counts by calculating the z-values of the light intensity values, which arrive at the different sensor elements. The analysis can be executed using a SALD-7500 Aggregate Sizer (Shimadzu Corporation, Kyoto, Japan) quantitative laser diffraction system (qLD).

In a preferred embodiment, the obtained powder has a median diameter (D50) of at least 100 μm, preferably at least 150 μm, more preferably at least 200 μm; and/or the median diameter (D50) is ≤600, preferably ≤500, more preferably ≤400, even more preferably ≤300 μm.

In a more preferred embodiment, the obtained powder has a median diameter (D50) of 125-500 μm, preferably 125-400 μm, even more preferably 125-300 μm, even more preferably 175-300 μm, most preferably 200-300 μm.

In an additional and/or alternative preferred embodiment of the third aspect of the disclosure, the obtained powder has a bulk density that is higher than what is typically obtained with spray drying of the solution according to the disclosure. This is advantageous, for example, for packaging the powder as more of the powder can be stored in the same volume compared to the powder obtained by spray drying. A higher bulk density also offers advantages in the pharma sector as known by the skilled person.

In an additional and/or alternative preferred embodiment, the obtained powder having a loose bulk density from about 400 to about 1000 g/L, a 100× tapped bulk density from about 500 to about 1150 g/L, a 625× tapped bulk density from about 500 to about 1200 g/L and/or a 1250× tapped bulk density from about 500 to about 1200 g/L.

In an additional and/or alternative preferred embodiment, the obtained powder having a loose bulk density from about 500 to about 1000 g/L, a 100× tapped bulk density from about 600 to about 1150 g/L, a 625× tapped bulk density from about 600 to about 1200 g/L and/or a 1250× tapped bulk density from about 650 to about 1200 g/L.

In a preferred embodiment, the obtained powder has a loose bulk density from about 750 to about 1000 g/L. In another preferred embodiment, the obtained powder has a loose bulk density from about 500 to about 750 g/L.

In an additional and/or alternative preferred embodiment, the obtained powder a 100× tapped bulk density of from about 850 to about 1150 g/L. In an alternative preferred embodiment, the obtained powder has 100× tapped bulk density from about 600 to about 850 g/L.

In an additional and/or alternative preferred embodiment, the obtained powder has a 625× tapped bulk density from about 850 to about 1150 g/L. In an alternative preferred embodiment, the obtained powder has a 625× tapped bulk density from about 700 to about 1100 g/L.

In an additional and/or alternative preferred embodiment, the obtained powder has a 1250× tapped bulk density of from about 1150 to about 1200 g/L. In an alternative preferred embodiment, the obtained powder has a 1250× tapped bulk density from about 750 to about 1100 g/L.

Hence, in a more preferred embodiment of the disclosure, the obtained powder has a loose bulk density from about 750 to about 1000 g/L, a 100× tapped bulk density from about 850 to about 1150 g/L, a 625× tapped bulk density from about 850 to about 1150 g/L and/or a 1250× tapped bulk density from about 1150 to about 1200 g/L.

Hence, in another more preferred embodiment, the obtained powder has a loose bulk density from about 500 to about 750 g/L, a 100× tapped bulk density from about 600 to about 850 g/L, a 625× tapped bulk density from about 700 to about 1100 g/L and/or a 1250× tapped bulk density from about 750 to about 1100 g/L.

As used herein, the term “bulk density” is the weight of the particles of a particulate solid (such as a powder) in a given volume, and is expressed in grams per liter (g/L). The total volume that the particles of a particulate solid occupy depends on the size of the particles themselves and the volume of the spaces between the particles. Entrapped air between and inside the particles also can affect the bulk density. Thus, a particulate solid consisting of large, porous particles with large inter-particulate spaces will have a lower bulk density than a particulate solid consisting of small, non-porous particles that compact closely together. Bulk density can be expressed in two forms: “loose bulk density” and “tapped bulk density.” Loose bulk density (also known in the art as “freely settled” or “poured” bulk density) is the weight of a particulate solid divided by its volume where the particulate solid has been allowed to settle into that volume of its own accord (e.g., a powder poured into a container).

Closer compaction of a particulate solid within a container may be achieved by tapping the container and allowing the particles to settle more closely together, thereby reducing volume while weight remains the same. Tapping therefore increases bulk density. Tapped bulk density (also known in the art as “tamped” bulk density) is the weight of a particulate solid divided by its volume where the particulate solid has been tapped and allowed to settle into the volume a precise number of times. The number of times the particulate solid has been tapped is typically when stating the tapped bulk density. For example, “100× tapped bulk density” refers to the bulk density of the particulate solid after it has been tapped 100 times.

Techniques for measuring bulk density are well known in the art. Loose bulk density may be measured using a measuring cylinder and weighing scales: the particulate solid is poured into the measuring cylinder and the weight and volume of the particulate solid; weight divided by volume gives the loose bulk density. Tapped bulk density can be measured using the same technique, with the addition of tapping the measuring cylinder a set number of times before measuring weight and volume. Automation of tapping ensures the number, timing and pressure of individual taps is accurate and consistent. Automatic tapping devices are readily available, an example being the Jolting Stampfvolumeter (STAV 203) from J. Englesmann A G.

### Nutritional Composition

In a fourth aspect, provided is a nutritional composition that is obtainable by a method according to the first and/or second aspect of the disclosure.

In an additional and/or alternative embodiment of the fourth aspect, a nutritional composition according to the disclosure comprises the dried powder according to the third aspect, optionally further comprising at least one probiotic organism.

In an additional and/or alternative embodiment, the nutritional composition is a food composition, a feed composition or a dietary composition. Preferably, the food composition is an infant formula or an infant supplement. Preferably, the feed composition is a pet food, animal milk replacer, veterinary product, post weaning feed or creep feed.

### Pharmaceutical Composition

In a fifth aspect, disclosure provided is a pharmaceutical composition that is obtainable by a method according to the first and/or second aspect of the disclosure.

In an additional and/or alternative embodiment of the fifth aspect, a pharmaceutical composition according to the disclosure comprises the dried powder according to the third aspect, optionally further comprising a pharmaceutically acceptable carrier, filler, preservative, solubilizer, diluent, excipient, salt, adjuvant and/or solvent. Such pharmaceutically acceptable carrier, filler, preservative, solubilizer, diluent, salt, adjuvant, solvent and/or excipient may, for instance, be found in Remington: The Science and Practice of Pharmacy, 20th Edition. Baltimore, MD: Lippincott Williams & Wilkins, 2000.

### Use of Dried Powder

In a sixth aspect, provided is the use of the dried powder according to the third aspect of the disclosure for the manufacture of nutritional composition, a food or feed composition, a dietary composition or a cosmetic composition. Preferably, the food composition is an infant formula or an infant supplement. Preferably, the feed composition is a pet food, animal milk replacer, veterinary product, post weaning feed or creep feed.

In a seventh aspect, provided is the use of the dried powder according to the third aspect of the disclosure for the manufacture of a pharmaceutical composition. Preferably, the composition comprises a pharmaceutically acceptable carrier, filler, preservative, solubilizer, diluent, excipient, salt, adjuvant and/or solvent.

### Specific Embodiments

This disclosure preferably relates to the following specific embodiments:
1. A method for drying an oligosaccharide and/or for obtaining an oligosaccharide in the form of a solid, the method comprising the steps of:
   i) providing a solution comprising an oligosaccharide; and
   ii) applying the solution to an agitated thin film dryer, preferably to obtain a solid, more preferably to obtain a powder,
wherein the oligosaccharide has a degree of polymerization (DP) that is less than 16, preferably less than 15, even more preferably less than 14, even more preferably less than 13, even more preferably less than 12, even more preferably less than 11, even more preferably less than 10, even more preferably less than 9, even more preferably less than 8, most preferably less than 7.
2. A method according to embodiment 1, wherein the solution comprises a mixture of at least 2, preferably at least three, more preferably at least 4, most preferably at least 5, different oligosaccharides, wherein each oligosaccharide has a degree of polymerization that is less than 16, preferably less than 15, even more preferably less than 14, even more preferably less than 13, even more preferably less than 12, even more preferably less than 11, even more preferably less than 10, even more preferably less than 9, even more preferably less than 8, most preferably less than 7.
3. A method according to embodiment 1 or 2, wherein the oligosaccharide or each oligosaccharide of the mixture has a degree of polymerization of at least two, preferably at least three.
4. A method according to any one of embodiments 1 to 3, wherein the oligosaccharide or any one, preferably at least two, more preferably at least three, even more preferably at least four, most preferably all, of the oligosaccharides in the mixture is/are a milk oligosaccharide, preferably mammalian milk oligosaccharide, more preferably a human milk oligosaccharide.
5. A method according to embodiment 4, wherein the milk oligosaccharide comprises a lactose at its reducing end.
6. A method according to any one of embodiments 1 to 3, wherein the oligosaccharide or any one, preferably at least two, more preferably at least three, even more preferably at least four, most preferably all, of the oligosaccharides in the mixture is/are an antigen of the human ABO blood group system.
7. A method according to any one of embodiments 1 to 3, wherein the oligosaccharide or any one, preferably at least two, more preferably at least three, even more preferably at least four, most preferably all, of the oligosaccharides in the mixture is/are a Lewis-type antigen oligosaccharide.
8. A method according to any one of embodiments 1 to 3, wherein the oligosaccharide or any one, preferably at least two, more preferably at least three, even more preferably at least four, most preferably all, of the oligosaccharides in the mixture is/are an animal oligosaccharide, preferably selected from the list consisting of N-glycans and O-glycans.
9. A method according to any one of embodiments 1 to 3, wherein the oligosaccharide or any one, preferably at least two, more preferably at least three, even more preferably at least four, most preferably all, of the oligosaccharides in the mixture is/are a plant oligosaccharide, preferably selected from the list consisting of N-glycans and O-glycans.
10. A method according to any one of embodiments 1 to 9, wherein the oligosaccharide or any one, preferably at least two, more preferably at least three, even more preferably at least four, most preferably all, of the oligosaccharides in the mixture has a solubility of at least 200 g/L, preferably at least 250 g/L, more preferably at least 300 g/L, even more preferably at least 350 g/L, even more preferably at least 400 g/L, even more preferably at least 450 g/L, most preferably at least 500 g/L, in an aqueous solution, preferably in water, and at ambient temperature, preferably at 25° C.
11. A method according to any one of embodiments 1 to 9, wherein the oligosaccharide or any one, preferably at least two, more preferably at least three, even more preferably at least four, most preferably all, of the oligosaccharides in the mixture has a solubility of at least 20%, preferably at least 22.5%, more preferably at least 25%, even more preferably at least 27.5%, even more preferably at least 30%, even more preferably at least 32.5%, even more preferably at least 35%, even more preferably at least 37.5%, even more preferably at least 40%, even more preferably at least 42.5%, even more preferably at least 45%, even more preferably at least 47.5%, most preferably at least 50%, in an aqueous solution, preferably in water, and at ambient temperature, preferably at 25° C., wherein the % solubility is calculated by dividing the mass of the oligosaccharide by the combined mass of the oligosaccharide and solution.
12. A method according to any one of embodiments 1 to 11, wherein the oligosaccharide or any one, preferably at least two, more preferably at least three, even more preferably at least four, most preferably all, of the oligosaccharides in the mixture is/are isolated from a microbial cultivation or fermentation, cell culture, enzymatic reaction or chemical reaction.
13. A method according to any one of embodiments 1 to 12, wherein the oligosaccharide or any one, preferably at least two, more preferably at least three, even more preferably at least four, most preferably all, of the oligosaccharides in the mixture is/are obtained from an in vitro and/or ex vivo culture of cells, preferably wherein the cells are chosen from the list consisting of a microorganism, the microorganism is preferably a bacterium, a yeast or a fungus; a plant cell; an animal cell or a protozoan cell.
14. A method according to any one of embodiments 1 to 13, wherein the solution is an aqueous solution.
15. A method according to any one of embodiments 1 to 14, wherein the solution does not comprise ethanol, preferably the solution does not contain an alcohol, more preferably the solution does not comprise a solvent.
16. A method according to any one of embodiments 1 to 15, wherein the solution has a pH of 4.0-7.0, preferably 4.0-6.0, more preferably 4.0-5.0.
17. A method according to any one of embodiments 1 to 16, wherein the solution further comprises at least one component, preferably the component is selected from any one of the list comprising monosaccharide, saccharide, protein, amino acid, vitamin, mineral, fatty acid, fat and/or lipid.
18. A method according to embodiment 17, wherein the solution further comprises at least one protein and/or at least one lipid.
19. A method according to embodiment 17 or 18, wherein the solution is a dairy solution, preferably obtained from an in vitro culture of cells and/or ex vivo culture of cells, wherein the cells are preferably chosen from the list consisting of a microorganism, the microorganism is preferably a bacterium, a yeast or a fungus; a plant cell; an animal cell or a protozoan cell.
20. A method according to any one of embodiments 1 to 19, wherein the solution comprises 25 wt. % to 90 wt. % (preferably 40 wt. % to 90 wt. %) water, 0.1 wt. % to 20 wt. % (preferably 0.1 wt. % to 15 wt. %, more preferably 3 wt. % to 7 wt. %, even more preferably 1 wt. % to 2 wt. %) of at least one protein, 0 wt. % to 60 wt. % of at least one fat and 0.0005 wt. % to 3 wt. % (preferably 0.1 wt. % to 3 wt. %, more preferably 0.1 wt. % to 1 wt. %) of at least one mineral, optionally 0.1 wt. % to 30 wt. % lactose is present.
21. A method according to any one of embodiments 1 to 20, wherein the solution comprises 0.1 wt. % to 20 wt. %, preferably 0.1 to 15 wt. %, more preferably 0.1 to 10 wt. %, even more preferably 0.1 to 5.0 wt. %, even more preferably 0.1 to 2.5 wt. %, most preferably 0.5 to 2.5 wt. %, of the oligosaccharide or the mixture of at least two oligosaccharides.
22. A method according to any one of embodiments 1 to 21, wherein the solution is obtained from an in vitro and/or ex vivo culture of cells, wherein the cells are preferably chosen from the list consisting of a microorganism, the microorganism is preferably a bacterium, a yeast or a fungus; a plant cell; an animal cell or a protozoan cell.
23. A method according to embodiment 22, wherein the solution is obtained from an in vitro and/or ex vivo culture of mammary epithelial cells, mammary myoepithelial cells and/or mammary progenitor cells, preferably wherein the cells are generated from non-mammary adult stem cells, more preferably wherein the cells are generated from mesenchymal stem cells.
24. A method according to any one of embodiments 1 to 23, wherein the oligosaccharide or mixture of oligosaccharides is present in the solution in an amount of at least 0.05% (w/v), at least 0.1% (w/v), at least 0.2% (w/v), at least 0.3% (w/v), at least 0.4% (w/v), at least 0.5% (w/v), at least 1.0% (w/v), at least 2.0% (w/v), at least 5.0% (w/v), at least 10% (w/v), at least 15% (w/v), at least 20% (w/v), at least 25% (w/v), at least 30% (w/v), at least 35% (w/v), at least 40% (w/v), at least 45% (w/v), at least 50% (w/v), at least 55% (w/v) or at least 60% (w/v), preferably at least 0.5% (w/v), more preferably at least 1.0% (w/v), even more preferably at least 2.0% (w/v), even more preferably at least 10% (w/v), even more preferably at least 20% (w/v), even more preferably at least 30% (w/v), most preferably at least 40% (w/v).
25. A method according to any one of embodiments 1 to 24, wherein the oligosaccharide or the mixture of oligosaccharides constitute at least 5.0%, at least 10%, at least 20%, at least 30%, at least 50%, at least 60%, at least 70%, at least 80%, at least 85%, at least 90%, at least 95%, at least 97% or at least 98% of the total weight of dry matter within the solution.
26. A method according to any one of embodiments 1 to 25, wherein the solution has a dry matter content of at least 2.0 wt. %, preferably at least 5.0 wt. %, even more preferably at least 10 wt. %, even more preferably at least 20 wt. %, even more preferably at least 30 wt. %, even more preferably at least 40 wt. %, most preferably at least 50 wt. %.
27. A method according to any one of embodiments 1 to 26, wherein the solution has a dry matter content that is not higher than or that is lower than 95 wt. %, preferably 90 wt. %, even more preferably 85 wt. %, most preferably 80 wt. %.
28. A method according to any one of embodiments 1 to 27, wherein the solution is obtained by mixing a first solution and at least a second solution, preferably wherein the solutions differ in composition, more preferably wherein the solutions differ in the quantity and/or quality of at least one component selected from any one of the list comprising monosaccharide, saccharide, protein, amino acid, vitamin, mineral, fatty acid, fat and/or lipid.
29. A method according to any one of embodiments 1 to 28, wherein the agitated thin film dryer is configured for agitated thin film drying of the solution.
30. A method according to any one of embodiments 1 to 29, wherein the agitated thin film dryer is a vertical thin film dryer, a horizontal thin film dryer or a combi thin film dryer, preferably the agitated thin film dryer is a vertical thin film dryer.
31. A method according to any one of embodiments 1 to 30, wherein the agitated thin film dryer is operated semi-batch wise or continuously, preferably continuously.
32. A method according to any one of embodiments 1 to 31, wherein the temperature of the heated surface of the agitated thin film dryer is at least 10° C.; preferably at least 15° C., more preferably at least 20° C., even more preferably at least 25° C., even more preferably at least 30° C., even more preferably at least 35° C., even more preferably at least 40° C., even more preferably at least 45° C., even more preferably at least 50° C., even more preferably at least 55° C., even more preferably at least 60° C., most preferably at least 50° C.
33. A method according to any one of embodiments 1 to 32, wherein the temperature of the heated surface of the agitated thin film dryer is ≤150° C., preferably ≤140° C., more preferably ≤130° C., even more preferably ≤120° C., even more preferably ≤110° C., even more preferably ≤100° C., even more preferably ≤90° C., even more preferably ≤80° C., even more preferably ≤75° C., most preferably ≤70° C.
34. A method according to any one of embodiments 1 to 33, wherein the temperature of the heated surface of the agitated thin film dryer ranges from 15° C. to 140° C., preferably from 25° C. to 140° C., more preferably from 25° C. to 125° C., even more preferably from 25° C. to 110° C., even more preferably from 25° C. to 90° c., even more preferably from 30° C. to 90° C., even more preferably from 30° C. to 80° C., even more preferably from 30° C. to 70° C., even more preferably from 40° C. to 90° C., even more preferably from 40° C. to 80° C., even more preferably from 40° C. to 70° C., even more preferably from 50° C. to 90° C., even more preferably from 50° C. to 80° C., even more preferably 50° c. to ≤75° C., most preferably from 50° C. to 70° C.
35. A method according to any one of embodiments 1 to 33, wherein the temperature of the heated surface of the agitated thin film dryer ranges from 15° C. to 70° C., preferably from 15° C. to 60° C., more preferably from 15° C. to 50° C., even more preferably from 15° C. to 40° C., most preferably from 20° C. to 40° C.
36. A method according to any one of embodiments 1 to 35, wherein the solution is dried under atmospheric pressure or under vacuum, preferably under vacuum.
37. A method according to any one of embodiments 1 to 36, wherein the solution is dried at a pressure of ≤1013 mbar, preferably ≤550 mbar, more preferably ≤250 mbar, even more preferably ≤100 mbar, even more preferably ≤50 mbar, even more preferably ≤40 mbar, even more preferably ≤25 mbar, even more preferably ≤10 mbar, even more preferably ≤1 mbar.
38. A method according to any one of embodiments 1 to 37, wherein the solution is dried at a pressure of 1.0-150 mbar, preferably 1.0-100 mbar, more preferably 1.0-50 mbar, even more preferably 1.0-40 mbar, even more preferably 1.0-25 mbar, even more preferably 1.0-10 mbar, even more preferably 1.0-50 mbar, most preferably 10-50 mbar.
39. A method according to any one of embodiments 1 to 38, wherein the solution is applied such that it forms a film on the heated surface of the agitated thin film dryer, wherein the height of the film is (i) at least 0.01 mm, preferably at least 0.05 mm, more preferably at least 0.1 mm, even more preferably at least 0.2 mm, even more preferably at least 0.3 mm, even more preferably at least 0.4 mm, most preferably at least 0.5 mm, and/or (ii)≤20 mm, preferably ≤15 mm, more preferably ≤10 mm, even more preferably ≤5 mm, even more preferably ≤2 mm, most preferably ≤1 mm.
40. A method according to any one of embodiments 1 to 39, wherein the solution is applied to the agitated thin film dryer at a rate of at least 2.0 kg per hour per m², preferably at least 2.5 kg per hour per m², more preferably at least 3.0 kg per hour per m², even more preferably at least 5.0 kg per hour per m², even more preferably at least 10.0 kg per hour per m², even more preferably at least 20.0 kg per hour per m²; and/or the solution is applied to the agitated thin film dryer at a rate of ≤200 kg per hour per m², preferably ≤100 kg per hour per m², more preferably ≤75 kg per hour per m², even more preferably ≤50 kg per hour per m², most preferably ≤30 kg per hour per m²
41. A method according to any one of embodiments 1 to 40, wherein the solution is obtained by a method comprising the steps of:
   (a) cultivating at least one cell, preferably a single cell, that is capable of producing the oligosaccharide or the mixture of at least two oligosaccharides in a suitable cultivation medium to form a cultivation broth, preferably wherein the cell is metabolically engineered for the production of the oligosaccharide or the mixture, and
   (b) purifying the oligosaccharide or the mixture from the cultivation broth by:
      (i) clarifying the cultivation broth, and
      (ii) removing salts and/or medium components form the clarified cultivation broth, and/or
      (iii) concentrating the oligosaccharide or the mixture in the clarified cultivation broth,
thereby providing a solution comprising a purified oligosaccharide or a purified mixture of at least 2 different oligosaccharides.
42. A method according to embodiment 41, wherein step (iii) comes before step (ii).
43. A method according to embodiment 41 or 42, wherein the mixture of at least 2 oligosaccharides is obtained by culturing (i) a single cell, preferably the single cell is metabolically engineered for the production of the oligosaccharide or the mixture, or (ii) at least two different cells, preferably wherein each different cell is metabolically engineered for the production of a different oligosaccharide or different mixture of oligosaccharides.
44. A method according to any one of embodiments 41 to 43, wherein the at least one cell is cultured in a minimal salt medium with a carbon source on which the at least one cell grows.
45. A method according to embodiment 44, wherein the minimal salt medium contains sulphate, phosphate, chloride, ammonium, calcium ion, magnesium ion, sodium, potassium ion, iron ion, copper ion, zinc ion, manganese ion, cobalt ion, and/or selenium ion.
46. A method according to any one of embodiment 44 or 45, wherein the carbon source comprises one or more of glucose, fructose, mannose, sucrose, maltose, corn steep liquor, lactose, galactose, high fructose syrup, starch, cellulose, hemi-cellulose, malto-oligosaccharides, trehalose, glycerol, acetate, citrate, lactate and pyruvate.
47. A method according to any one of embodiments 41 to 46, wherein the step (i) of clarifying the cultivation or fermentation broth comprises one or more of clarification, clearing, filtration, microfiltration, centrifugation, decantation and ultrafiltration, preferably the step (i) further comprising use of a filter aid and/or flocculant; preferably the filtration aid is an adsorbing agent, more preferably active carbon.
48. A method according to embodiment 47, wherein the step (i) comprises subjecting the cultivation or fermentation broth to two membrane filtration steps using different membranes.
49. A method/process according to any one of embodiments 41 to 48, wherein the step (ii) of removing salts and/or medium components from the clarified cultivation or fermentation broth comprises at least one or more of nanofiltration, dialysis, electrodialysis, use of activated charcoal or carbon, use of charcoal, tangential flow high-performance filtration, tangential flow ultrafiltration, affinity chromatography, ion exchange, cation exchange, anion exchange, mixed bed ion exchange, simulated moving bed chromatography, ion exchange chromatography, hydrophobic interaction chromatography, gel filtration, ligand exchange chromatography, column chromatography, cation exchange adsorbent resin, and use of ion exchange resin.
50. A method according to embodiment 49, wherein the step (ii) of removing salts and/or medium components from the clarified cultivation or fermentation broth comprises anion exchange wherein the anion exchange resin is characterized to have a moisture content of 30-48% and preferably microporous or a gel type anion exchanger, preferably selected from the group Dowex 1-X8, XA4023, XA3112, DIAION SA20A, DIAION SA10A.
51. A method according to any one of embodiments 41 to 50, wherein step (ii) comprises a treatment with a mixed bed ion exchange resin, preferably mixed bed column of Diaion SA20A and Amberlite FPC 22H mixed in a ratio 1,1:1 to 1,9:1.
52. A method according to any one of embodiments 41 to 51, wherein the step (iii) of concentrating comprises one or more of nanofiltration, reverse osmosis and evaporation, wiped film evaporation, and falling film evaporation.
53. A method according to any one of embodiments 41 to 52, wherein the step (i) comprises a first step of clarification by microfiltration.
54. A method according to any one of embodiments 41 to 52, wherein the step (i) comprises a first step of clarification by centrifugation.
55. A method according to any one of embodiments 41 to 52, wherein the step (i) comprises a first step of clarification by flocculation.
56. A method according to any one of embodiments 41 to 52, wherein the step (i) comprises a first step of clarification by ultrafiltration.
57. A method according to any one of embodiments 41 to 56, wherein the step (i) comprises ultrafiltration.
58. A method according to embodiment 56 or 57, wherein in step (i) the ultrafiltration has a molecular weight cut-off equal to or higher than 1 kDa, 2 kDa, 3 kDa, 4 kDa, 5 kDa, 6 kDa, 7 kDa, 8 kDa, 9 kDa, 10 kda, 11 kDa, 12 kDa, 13 kDa, 14 kDa, 15 kDa.
59. A method according to any one of embodiments 41 to 58, wherein step (i) comprises two consecutive ultrafiltrations, and wherein the membrane molecular weight cut-off of the first ultrafiltration is higher than that of the second ultrafiltration.
60. A method according to any one of embodiments 41 to 59, wherein step (ii) comprises nanofiltration and/or electrodialysis.
61. A method according to embodiment 60, wherein the nanofiltration and/or electrodialysis is performed twice.
62. A method according to embodiment 61, wherein the nanofiltration and/or electrodialysis steps are performed consecutively.
63. A method according to any one of embodiments 56 to 62, wherein the ultrafiltration permeate of step (i) is nanofiltered and/or electrodialyzed in step (ii).
64. A method according to any one of embodiments 41 to 52 or any one of embodiments 56 to 63 wherein the step (i) is ultrafiltration, the step (ii) is nanofiltration and/or electrodialysis treatment combined with treatment with an ion exchange resin and/or chromatography.
65. A method according to embodiment 64, wherein the ion exchange resin is a strongly acidic cation exchange resin and/or a weakly basic anion exchange resin.
66. A method according to embodiment 65, wherein the ion exchange resin is a strongly acidic cation exchange resin and a weakly basic anion exchange resin.
67. A method according to any one of embodiments 41 to 66, wherein the step (ii) comprises treatment with a strong cation exchange resin in H+ form or Na+ form and a weak anion exchange resin in free base form, preferably in Cl− form, alternatively preferably in OH− form.
68. A method according to any one of embodiments 65 to 67, wherein the treatment with a strong cation exchange resin in H+− form or Na+ form is directly followed by a treatment with a weak anion exchange resin in free base form.
69. A method according to any one of embodiments 41 to 68 that does not comprise electrodialysis.
70. A method according to any one of embodiments 41 to 68, wherein step (ii) comprises electrodialysis.
71. A method according to any one of embodiments 65 to 68 or 70, wherein the treatment with a strong cation exchange resin and/or a weak anion exchange resin is preceded by ultrafiltration followed by nanofiltration and/or electrodialysis.
72. A method according to any one of embodiments 41 to 71, wherein any one or more of the steps i) to iii) is performed more than once.
73. A method according to any one of embodiments 63 to 72, wherein the molecular weight cut-off of the nanofiltration membrane in step (ii) is lower than that of the ultrafiltration membrane in step (i).
74. A method according to any of embodiments 63 to 73, wherein the molecular weight cut-off of the nanofiltration membrane in step (ii) is equal or higher than 200 Da, 300 Da, 400 Da, 500 Da, 600 Da, 700 Da, 800 Da, 900 Da, or 1000 Da.
75. A method according to any of the embodiments 49 to 74, wherein step (ii) comprises an ion exchange resin treatment and/or chromatography on a neutral solid phase.
76. A method according to any one of embodiments 41 to 75, wherein step (i) is preceded by an enzymatic treatment.
77. A method according to embodiment 76, wherein the enzymatic treatment comprises incubation of the cultivation or fermentation broth with one or more enzymes selected from the group consisting of: glycosidase, lactase, b-galactosidase, fucosidase, sialidase, maltase, amylase, hexaminidase, glucuronidase, trehalase, and invertase.
78. A method according to embodiment 76 or 77, wherein the enzymatic treatment converts lactose and/or sucrose to monosaccharides.
79. A method according to any one of embodiments 41 to 78, wherein the method further comprises a decolorization step.
80. A method according to any one of embodiments 41 to 79, wherein the purified oligosaccharide or the purified mixture of at least 2 different oligosaccharides is further concentrated to a syrup of at least 40 wt. %.
81. A method according to any one of embodiments 41 to 80, wherein the solution comprising a purified oligosaccharide or a purified mixture of at least 2 different oligosaccharides has a protein content below 100 mg per kg dry solid, DNA content below 10 ng per gram dry solid and/or endotoxin content below 10000 EU per gram dry solid.
82. A method according to any one of embodiments 41 to 81, wherein the cell is a microorganism, preferably a bacterium, a yeast or a fungus; a plant cell; an animal cell or a protozoan cell,
   preferably the bacterium is an Escherichia coli strain, more preferably an Escherichia coli strain that is a K-12 strain, even more preferably the Escherichia coli K-12 strain is E. coli MG1655,
   preferably the fungus belongs to a genus chosen from the group comprising Rhizopus, Dictyostelium, Penicillium, Mucor or Aspergillus,
   preferably the yeast belongs to a genus chosen from the group comprising Saccharomyces, Zygosaccharomyces, Pichia, Komagataella, Hansenula, Yarrowia, Starmerella, Kluyveromyces or Debaromyces,
   preferably the plant cell is an algal cell or is derived from tobacco, alfalfa, rice, tomato, cotton, rapeseed, soy, maize, or corn plant,
   preferably the animal cell is derived from non-human mammals, birds, fish, invertebrates, reptiles, amphibians or insects or is a genetically modified cell line derived from human cells excluding embryonic stem cells, more preferably the human and non-human mammalian cell is an epithelial cell, a mammary epithelial cell, a mammary myoepithelial cell, a mammary progenitor cell, an embryonic kidney cell, a fibroblast cell, a COS cell, a Chinese hamster ovary (CHO) cell, a murine myeloma cell, an NIH-3T3 cell, a non-mammary adult stem cell or derivatives thereof, more preferably the insect cell is derived from Spodoptera frugiperda, Bombyx mori, Mamestra brassicae, Trichoplusia ni or Drosophila melanogaster,
   preferably the protozoan cell is a Leishmania tarentolae cell.
83. A dried powder obtainable by any one of methods 1 to 82, preferably wherein the dried powder is white to off-white.
84. A dried powder according to embodiment 83, wherein the powder contains at least 70 wt. %, preferably at least 80 wt. %, more preferably at least 85 wt. %, even more preferably at least 90 wt. %, even more preferably at least 93 wt. %, even more preferably at least 95 wt. %, even more preferably at least 97 wt. %, most preferably at least 98 wt. %, of dry matter.
85. A dried powder according to embodiment 83 or 84, wherein the oligosaccharide or the mixture of oligosaccharides constitutes at least 5.0%, at least 10%, at least 20%, at least 30%, at least 40%, at least 50%, at least 60%, at least 70%, at least 80%, at least 85%, at least 90%, at least 95%, at least 97% or at least 98% of the total weight of dry matter within the dried powder.
86. A dried powder according to any one of embodiments 83 to 85, wherein the powder contains ≤15 wt. %, preferably ≤10 wt. %, more preferably ≤9 wt. %, more preferably ≤8 wt. %, more preferably ≤7 wt. %, even more preferably ≤5 wt. %, even more preferably ≤4 wt. % of liquid, even more preferably ≤3 wt. % of liquid, even more preferably ≤2 wt. % of liquid, most preferably ≤1 wt. %, preferably wherein the liquid is water.
87. A dried powder according to any one of embodiments 83 to 86, wherein the powder has a median diameter (D50) of at least 100 μm, preferably at least 150 μm, more preferably at least 200 μm; and/or the median diameter (D50) is ≤600, preferably ≤500, more preferably ≤400, even more preferably ≤300 μm.
88. A dried powder according to any one of embodiments 83 to 87, wherein the powder exhibits:
   a loose bulk density of from about 400 to 1000 g/L,
   a 100× tapped bulk density of from about 500 to about 1150 g/L,
   a 625× tapped bulk density of from about 500 to about 1200 g/L, and/or
   a 1250× tapped bulk density of from about 500 to about 1200 g/L.
89. A dried powder according to any one of embodiments 83 to 87, wherein the powder exhibits:
   a loose bulk density of from about 500 to 1000 g/L,
   a 100× tapped bulk density of from about 600 to about 1150 g/L,
   a 625× tapped bulk density of from about 600 to about 1200 g/L, and/or
   a 1250× tapped bulk density of from about 650 to about 1200 g/L.
90. A dried powder according to embodiment 88 or 89, wherein the powder exhibits:
   a loose bulk density of from about 750 to 700 g/L,
   a 100× tapped bulk density of from about 850 to about 1150 g/L,
   a 625× tapped bulk density of from about 850 to about 1150 g/L, and/or
   a 1250× tapped bulk density of from about 1150 to about 1200 g/L.
91. A dried powder according to embodiment 88 or 89, wherein the powder exhibits:
   a loose bulk density of from about 500 to 750 g/L,
   a 100× tapped bulk density of from about 600 to about 850 g/L,
   a 625× tapped bulk density of from about 700 to about 1100 g/L, and/or
   a 1250× tapped bulk density of from about 750 to about 1100 g/L.
92. A nutritional composition obtainable by any one of methods 1 to 82, optionally further comprising at least one probiotic organism.
93. A nutritional composition comprising the dried powder according to any one of embodiments 82 to 91, optionally further comprising at least one probiotic organism.
94. A nutritional composition according to embodiment 92 or 93, wherein the nutritional composition is a food composition, a feed composition or a dietary composition.
95. A nutritional composition according to embodiment 94, wherein the food composition is an infant formula or an infant supplement.
96. A nutritional composition according to embodiment 94, wherein the feed composition is a pet food, animal milk replacer, veterinary product, post weaning feed or creep feed.
97. A pharmaceutical composition obtainable by any one of methods 1 to 82, optionally further comprising a pharmaceutically acceptable carrier, filler, preservative, solubilizer, diluent, excipient, salt, adjuvant and/or solvent.
98. A pharmaceutical composition comprising the dried powder according to any one of embodiments 83 to 91, optionally further comprising a pharmaceutically acceptable carrier, filler, preservative, solubilizer, diluent, excipient, salt, adjuvant and/or solvent.
99. Use of a dried powder according to any one of embodiments 83 to 91 for the manufacture of a nutritional composition, a food or feed composition, a dietary composition or a cosmetic composition.
100. Use of a dried powder according to embodiment 99, wherein the food composition is an infant formula or an infant supplement.
101. Use of a dried powder according to embodiment 99, wherein the feed composition is a pet food, animal milk replacer, veterinary product, post weaning feed or creep feed.
102. Use of a dried powder according to any one of embodiments 82 to 91 for the manufacture of a pharmaceutical composition.

### Definitions

The words used in this specification to describe the disclosure and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The various aspects and embodiments disclosed herein are to be understood not only in the order and context specifically described in this specification, but to include any order and any combination thereof. Each embodiment as identified herein may be combined together unless otherwise indicated. All patent and literature references cited in the present specification are hereby incorporated by reference in their entirety. Unless specifically stated otherwise, all words used in the singular number shall be deemed to include the plural and vice versa. Unless defined otherwise, all technical and scientific terms used herein generally have the same meaning as commonly understood by one of ordinary skill in the art to which this disclosure belongs. Generally, the nomenclature used herein and the laboratory procedures in cell culture, molecular genetics, organic chemistry and nucleic acid chemistry and hybridization described herein are those well-known and commonly employed in the art. Standard techniques are used for nucleic acid and peptide synthesis. Generally, enzymatic reactions and purification steps are performed according to the manufacturer's specifications.

In the drawings and specification, there have been disclosed embodiments of the disclosure, and although specific terms are employed, the terms are used in a descriptive sense only and not for purposes of limitation, the scope of the invention being set forth in the following claims. It must be understood that the illustrated embodiments have been set forth only for the purposes of example and that it should not be taken as limiting the invention. It will be apparent to those skilled in the art that alterations, other embodiments, improvements, details and uses can be made consistent with the letter and spirit of the invention herein and within the scope of this invention, which is limited only by the claims, construed in accordance with the patent law, including the doctrine of equivalents. In the claims that follow, reference characters used to designate claim steps are provided for convenience of description only, and are not intended to imply any particular order for performing the steps (unless specifically stated otherwise).

In this document and in its claims, the verbs “to comprise,” “to have” and “to contain,” and their conjugations are used in their non-limiting sense to mean that items following the word are included, but items not specifically mentioned are not excluded. The verb “to consist essentially of” means that a solution as defined herein may comprise additional component(s) than the ones specifically identified, the additional component(s) not altering the unique characteristic of the invention. Throughout the document and claims, unless specifically stated otherwise, the verbs “to comprise,” “to have” and “to contain,” and their conjugations, may be preferably replaced by “to consist” (and its conjugations) or “to consist essentially of” (and its conjugations) and vice versa. In addition, reference to an element by the indefinite article “a” or “an” does not exclude the possibility that more than one of the element is present, unless the context clearly requires that there be one and only one of the elements. The indefinite article “a” or “an” thus usually means “at least one.” The word “about” or “approximately” when used in association with a numerical value (e.g., about 10) preferably means that the value may be the given value (e.g., 10) more or less 0.1% of the value.

The term “monosaccharide” as used herein refers to a sugar that is not decomposable into simpler sugars by hydrolysis, is classed either an aldose or ketose, and contains one or more hydroxyl groups per molecule. Monosaccharides are saccharides containing only one simple sugar.

The term “oligosaccharide” as used in the context of this disclosure refers to a saccharide containing less than 16 monosaccharides, i.e., the degree of polymerization (DP) is lower than 16. Preferably, the oligosaccharide according to the disclosure contains at least 2 monosaccharides, more preferably at least 3 monosaccharides. The oligosaccharide as used in this disclosure can be a linear structure or can include branches. The linkage (e.g., glycosidic linkage, galactosidic linkage, glucosidic linkage, etc.) between two sugar units can be expressed, for example, as 1,4, 1->4, or (1-4), used interchangeably herein. Each monosaccharide can be in the cyclic form (e.g., pyranose or furanose form). An oligosaccharide can contain both alpha- and beta-glycosidic bonds or can contain only beta-glycosidic bonds.

The term “polysaccharide” as used in the context of this disclosure refers to a saccharide containing a plurality of repeating units comprised of simple sugars. In the context of the disclosure, the polysaccharide preferably has a degree of polymerization that is at least 40 (and preferably ≤3000).

The terms “LNT II,” “LNT-II,” “LN3,” “lacto-N-triose II,” “lacto-N-triose II,” “lacto-N-triose,” “lacto-N-triose” and “GlcNAc-β1,3-Gal-β1,4-Glc” are used interchangeably.

The terms “LNT,” “lacto-N-tetraose,” “lacto-N-tetraose” and “Gal-β1,3-GlcNAc-β1,3-Gal-β1,4Glc” are used interchangeably.

The terms “LNnT,” “lacto-N-neotetraose,” “lacto-N-neotetraose,” “neo-LNT” and “Galβ1-4GlcNAcβ1-3Galβ1-4Glc” are used interchangeably.

The terms “2′ fucosyllactose,” “2′-fucosyllactose,” “alpha-1,2-fucosyllactose,” “alpha 1,2 fucosyllactose,” “α-1,2-fucosyllactose,” “a 1,2 fucosyllactose,” “Fuc-α1,2-Gal-β1,4-Glc,” “2FL” and “2′FL” are used interchangeably.

The terms “3-fucosyllactose,” “alpha-1,3-fucosyllactose,” “alpha 1,3 fucosyllactose,” “α-1,3-fucosyllactose,” “α 1,3 fucosyllactose,” “Gal-β1,4-(Fuc-α1,3-)Glc,” “3FL” and “3-FL” are used interchangeably.

The terms “difucosyllactose,” “di-fucosyllactose,” “lactodifucotetraose,” “2′,3-difucosyllactose,” “2′,3 difucosyllactose,” “α-2′,3-fucosyllactose,” “α 2′,3 fucosyllactose, “Fuc-α1,2-Gal-β1,4-(Fuc-α1,3-)Glc,” “DFLac,” 2′,3 diFL,” “DFL,” “DiFL” and “diFL” are used interchangeably.

The terms “LNFP-1,” “lacto-N-fucopentaose I,” “LNFP I,” “LNF I OH type I determinant,” “LNF I,” “LNF 1,” “LNF 1,” “Blood group H antigen pentaose type 1” and “Fuc-α1,2-Gal-β1,3-GlcNAc-β1,3-Gal-β1,4-Glc” are used interchangeably.

The terms “GalNAc-LNFP-I,” “blood group A antigen hexaose type I,” and “GalNAc-α1,3-(Fuc-α1,2)-Gal-β1,3-GlcNAc-β1,3-Gal-β1,4-Glc” are used interchangeably.

The terms “Gal-LNFP-I,” “blood group B antigen hexaose type I” and “Gal-α1,3-(Fuc-α1,2)-Gal-β1,3-GlcNAc-β1,3-Gal-β1,4-GlC” are used interchangeably.

The terms “LNFP-II,” “lacto-N-fucopentaose II” and “Gal-β1,3-(Fuc-α1,4)-GlcNAc-β1,3-Gal-β1,4-Glc” are used interchangeably.

The terms “LNFP-III,” “lacto-N-fucopentaose III” and “Gal-β1,4-(Fuc-α1,3)-GlcNAc-β1,3-Gal-β1,4-Glc” are used interchangeably.

The terms “LNFP-V,” “lacto-N-fucopentaose V” and “Gal-β1,3-GlcNAc-β1,3-Gal-β1,4-(Fuc-α1,3)-GlC” are used interchangeably.

The terms “LNDFH I,” “Lacto-N-difucohexaose I,” “LNDFH-I,” “LDFH I,” “Le^{b}-lactose,” “Lewis-b hexasaccharide” and “Fuc-α1,2-Gal-β1,3-[Fuc-α1,4]-GlcNAc-β1,3-Gal-β1,4-Glc” are used interchangeably.

The terms “LNDFH II,” “Lacto-N-difucohexaose II,” “Lewis a-Lewis x,” “LDFH II” and “Fuc-α1,4-(Gal-β1,3)-GlcNAc-β1,3-Gal-β1,4-(Fuc-α1,3)-Glc” are used interchangeably.

The terms “lewis b-lewis x” and “Fucα1,4-[Fuc-α1,2-Galβ1,3]-GlcNAc-β1,3-Gal-β1,4-[Fuc-α1,3]-GlC” are used interchangeably.

The terms “MFLNH III,” “monofucosyllacto-N-hexaose-III” and “Gal-β1,4-[Fuc-α1,3]-GlcNAc-β1,6-[Gal-β1,3-GlcNAc-β1,3]-Gal-β1,4-Glc” are used interchangeably.

The terms “DFLNH (a),” “difucosyllacto-N-hexaose (a)” and “Gal-β1,4-[Fuc-α1,3]-GlcNAc-β1,6-[Fuc-α1,2-Gal-β1,3-GlcNAc-β1,3]-Gal-β1,4-Glc” are used interchangeably.

The terms “DFLNH,” “difucosyllacto-N-hexaose” and “Gal-β1,4-[Fuc-α1,3]-GlcNAc-β1,6-[Fuc-α1,4-[Gal-β1,3]-GlcNAc-β1,3]-Gal-β1,4-Glc” are used interchangeably.

The terms “TFLNH,” “trifucosyllacto-N-hexaose” and “Gal-β1,4-[Fuc-α1,3]-GlcNAc-β1,6-[Fuc-α1,4-[Fuc-α1,2-Gal-β1,3]-GlcNAc-β1,3]-Gal-β1,4-Glc” are used interchangeably.

The terms “LNnFP I,” “Lacto-N-neofucopentaose I” and “Fuc-α1,2-Gal-β1,4-GlcNAc-β1,3-Gal-β1,4-Glc” are used interchangeably.

The terms “LNFP-VI,” “LNnFP V,” “lacto-N-neofucopentaose V” and “Gal-β1,4-G1cNAc-β1,3-Gal-β1,4-(Fuc-α1,3)-Glc” are used interchangeably.

The terms “LNnDFH,” “Lacto-N-neoDiFucohexaose,” “Lewis× hexaose” “Gal-β1,4-(Fuc-α1,3)-GlcNAc-β1,3-Gal-β1,4-(Fuc-α1,3)-Glc” are used interchangeably.

The terms “2′-fucosyllacto-N-biose,” “2′FLNB” and “Fuc-α1,2-Gal-β1,3-GlcNAc” are used interchangeably.

The terms “4-fucosyllacto-N-biose,” “4FLNB” and “Fuc-α1,4-[Gal-β1,3-]GlcNAc” are used interchangeably.

The terms “difucosyllacto-N-biose,” “diFLNB” and “Fuc-α1,4-[Fuc-α1,2-Gal-β1,3-]GlcNAc” are used interchangeably.

The terms “2′-fucosyl-N-acetyllactosamine,” “2′FlacNAc” and “Fuc-α1,2-Gal-β1,4-GlcNAc” are used interchangeably.

The terms “3-fucosyl-N-acetyllactosamine,” “3FlacNAc” and “Gal-β1,4-(Fuc-α1,3-)GlcNAc” are used interchangeably.

The terms “difucosyl-N-acetyllactosamine,” “diFlacNAc” and “Fuc-α1,2-Gal-β1,4-[Fuc-α1,3-]GlcNAc” are used interchangeably.

The terms “3′ sialyllactose,” “3′-sialyllactose,” “alpha-2,3-sialyllactose,” “alpha 2,3 sialyllactose,” “α-2,3-sialyllactose,” “a 2,3 sialyllactose,” “3SL,” “Sia-α2,3-Gal-β1,4-Glc” and “3′SL” are used interchangeably.

The terms “6′ sialyllactose,” “6′-sialyllactose,” “alpha-2,6-sialyllactose,” “alpha 2,6 sialyllactose,” “α-2,6-sialyllactose,” “a 2,6 sialyllactose,” “6SL,” “Sia-α2,6-Gal-β1,4-Glc” and “6′SL” are used interchangeably.

The terms “3,6-disialyllactose” and “Neu5Ac-α2,3-Neu5Ac-α2,6-Gal-β1,4-GlC” are used interchangeably.

The terms “6,6′-disialyllactose” and “Neu5Ac-α2,6-Neu5Ac-α2,6-Gal-β1,4-Glc” are used interchangeably.

The terms “8,3-disialyllactose” and “Neu5Ac-α2,8-Neu5Ac-α2,3-Gal-β1,4-GlC” are used interchangeably.

The terms “3'S-2′FL,” “3′-sialyl-2′-fucosyllactose” and “Neu5Ac-α2,3-[Fuc-α1,2-]Gal-β1,4-Glc” are used interchangeably.

The terms “6'S-2′FL,” “6′-sialyl-2′-fucosyllactose” and “Neu5Ac-α2,6-[Fuc-α1,2-]Gal-β1,4-GlC” are used interchangeably.

The terms “3'S-3-FL,” “3′-sialyl-3-fucosyllactose” and “Neu5Ac-α2,3-Gal-β 1,4-[Fuc-α1,3]Glc” are used interchangeably.

The terms “6'S-3-FL,” “6′-sialyl-3-fucosyllactose” and “Neu5Ac-α2,6-Gal-β1,4-[Fuc-α1,3]Glc” are used interchangeably.

The terms “LSTa,” “LS-Tetrasaccharide a,” “Sialyl-lacto-N-tetraose a,” “sialyllacto-N-tetraose a” and “Neu5Ac-α2,3-Gal-b1,3-GlcNAc-b1,3-Gal-b1,4-Glc” are used interchangeably.

The terms “LSTb,” “LS-Tetrasaccharide b,” “Sialyl-lacto-N-tetraose b,” “sialyllacto-N-tetraose b” and “Gal-b1,3-(Neu5Ac-α2,6)-GlcNAc-b1,3-Gal-b1,4-Glc” are used interchangeably.

The terms “LSTc,” “LS-Tetrasaccharide c,” “Sialyl-lacto-N-tetraose c,” “sialyllacto-N-tetraose c,” “sialyllacto-N-neotetraose c” and “Neu5Ac-α2,6-Gal-b1,4-GlcNAc-b1,3-Gal-b1,4-Glc” are used interchangeably.

The terms “LSTd,” “LS-Tetrasaccharide d,” “Sialyl-lacto-N-tetraose d,” “sialyllacto-N-tetraose d,” “sialyllacto-N-neotetraose d” and “Neu5Ac-α2,3-Gal-b1,4-GlcNAc-b1,3-Gal-b1,4-Glc” are used interchangeably.

The terms “3′-sialyllacto-N-biose,” “3′SLNB” and “Neu5Ac-α2,3-Gal-b1,3-GlcNAc” are used interchangeably.

The terms “6′-sialyllacto-N-biose,” “6′SLNB” and “Neu5Ac-α2,6-Gal-b1,3-GlcNAc” are used interchangeably.

The terms “monofucosylmonosialyllacto-N-octaose,” “sialyl Lewis a,” “sialyl Lea,” “5-acetylneuraminyl-(2-3)-galactosyl-(1-3)-(fucopyranosyl-(1-4))-N-acetylglucosamine” and “Neu5Ac-α2,3-Gal-β1,3-[Fuc-α1,4]-GlcNAc” are used interchangeably.

The terms “3′-sialyllactosamine,” “3′SLacNAc” and “Neu5Ac-α2,3-Gal-b1,4-GlcNAc” are used interchangeably.

The terms “6′-sialyllactosamine,” “6′SLacNAc” and “Neu5Ac-α2,6-Gal-b1,4-GlcNAc” are used interchangeably.

The terms “sialyl Lewis x,” “sialyl Lex,” “5-acetylneuraminyl-(2-3)-galactosyl-(1-4)-(fucopyranosyl-(1-3))-N-acetylglucosamine” and “Neu5Ac-α2,3-Gal-β1,4-[Fuc-α1,3-]GlcNAc” are used interchangeably.

The terms “DSLNnT” and “Disialyllacto-N-neotetraose” are used interchangeably and refer to Neu5Ac-α2,6-[Neu5Ac-α2,6-Gal-b1,4-GlcNAc-b1,3]-Gal-b1,4-Glc.

The terms “DSLNT” and “Disialyllacto-N-tetraose” are used interchangeably and refer to Neu5Ac-α2,6-[Neu5Ac-α2,3-Gal-b1,3-GlcNAc-b1,3]-Gal-b1,4-Glc.

The terms “alpha-tetrasaccharide” and “A-tetrasaccharide” are used interchangeably and refer to GalNAc-a1,3-(Fuc-α1,2)-Gal-b1,4-Glc.

The term “cultivation” refers to the culture medium wherein the cell is cultivated or fermented, the cell itself, and the oligosaccharide(s) that is/are produced by the cell in whole broth, i.e., inside (intracellularly) as well as outside (extracellularly) of the cell.

The term “precursor” as used herein refers to substances that are taken up or synthetized by the cell for the specific production of an oligosaccharide (or mixture of oligosaccharides) as present in a solution according to this disclosure. In this sense a precursor can be an acceptor as defined later herein, but can also be another substance, metabolite, which is first modified within the cell as part of the biochemical synthesis route of the oligosaccharide(s). The term “acceptor” as used herein refers to a mono-, di- or oligosaccharide that can be modified by a glycosyltransferase. Examples of such acceptors comprise glucose, galactose, fructose, glycerol, sialic acid, fucose, mannose, maltose, sucrose, lactose, lacto-N-triose, lacto-N-tetraose (LNT), lacto-N-neotetraose (LNnT), lacto-N-pentaose (LNP), lacto-N-neopentaose, para lacto-N-pentaose, para lacto-N-neopentaose, lacto-N-novopentaose I, lacto-N-hexaose (LNH), lacto-N-neohexaose (LNnH), para lacto-N-neohexaose (pLNnH), para lacto-N-hexaose (pLNH), lacto-N-heptaose, lacto-N-neoheptaose, para lacto-N-neoheptaose, para lacto-N-heptaose, lacto-N-octaose (LNO), lacto-N-neooctaose, iso lacto-N-octaose, para lacto-N-octaose, iso lacto-N-neooctaose, novo lacto-N-neooctaose, para lacto-N-neooctaose, iso lacto-N-nonaose, novo lacto-N-nonaose, lacto-N-nonaose, lacto-N-decaose, iso lacto-N-decaose, novo lacto-N-decaose, lacto-N-neodecaose, and oligosaccharide containing 1 or more N-acetyllactosamine units and/or 1 or more lacto-N-biose units or an intermediate into oligosaccharide, fucosylated and sialylated versions thereof.

### EXAMPLES

The invention will be described in more detail in the examples. The following examples will serve as further illustration and clarification of this disclosure and are not intended to be limiting in any way.

### Example 1: Materials and Methods

### Media and Cultivation

The Luria Broth (LB) medium consisted of 1% tryptone peptone (Difco, Erembodegem, Belgium), 0.5% yeast extract (Difco) and 0.5% sodium chloride (VWR. Leuven, Belgium). The minimal medium used in the cultivation experiments in 96-well plates or in shake flasks contained 2.00 g/L NH4Cl, 5.00 g/L (NH4)2SO4, 2.993 g/L KH2PO4, 7.315 g/L K2HPO4, 8.372 g/L MOPS, 0.5 g/L NaCl, 0.5 g/L MgSO4·7H2O, 30 g/L sucrose or 30 g/L glycerol, 1 ml/L vitamin solution, 100 μl/L molybdate solution, and 1 mL/L selenium solution. As specified in the respective examples, 0.30 g/L sialic acid, 20 g/L lactose, 20 g/L LacNAc, 20 g/L LNnT, 20 g/L LNT and/or 20 g/L LNB were additionally added to the medium as precursor(s).

The minimal medium was set to a pH of 7 with 1M KOH. Vitamin solution consisted of 3.6 g/L FeCl2.4H2O, 5 g/L CaCl2·2H2O, 1.3 g/L MnCl2·2H2O, 0.38 g/L CuCl2.2H2O, 0.5 g/L CoCl2·6H2O, 0.94 g/L ZnCl2, 0.0311 g/L H3BO4, 0.4 g/L Na2EDTA·2H2O and 1.01 g/L thiamine·HCl. The molybdate solution contained 0.967 g/L NaMoO4·2H2O. The selenium solution contained 42 g/L SeO2.

The minimal medium for fermentations contained 6.75 g/L NH4Cl, 1.25 g/L (NH4)2SO4, 2.93 g/L KH2PO4 and 7.31 g/L KH2PO4, 0.5 g/L NaCl, 0.5 g/L MgSO4·7H2O, 30 g/L sucrose or 30 g/L glycerol, 1 mL/L vitamin solution, 100 μL/L molybdate solution, and 1 mL/L selenium solution with the same composition as described above. As specified in the respective examples, 0.30 g/L sialic acid, 20 g/L lactose, 20 g/L LacNAc, 20 g/L LNnT, 20 g/L LNT and/or 20 g/L LNB were additionally added to the medium as precursor(s).

Complex medium was sterilized by autoclaving (121° C., 21 min) and minimal medium by filtration (0.22 μm Sartorius).

A preculture for the bioreactor was started from an entire 1 mL cryovial of a certain strain, inoculated in 250 mL or 500 mL minimal medium in a 1 L or 2.5 L shake flask and incubated for 24 h at 37° C. on an orbital shaker at 200 rpm. A 5 or 30 L bioreactor was then inoculated (250 mL inoculum in 2 L batch medium or 1 L in 17 L batch medium); the process was controlled by MFCS control software (Sartorius Stedim Biotech, Melsungen, Germany). Culturing condition were set to 37° C., and maximal stirring; pressure gas flow rates were dependent on the strain and bioreactor. The pH was controlled at 6.8 using 0.5 M H2SO4 and 20% NH4OH. The exhaust gas was cooled. 10% solution of silicone antifoaming agent was added when foaming raised during the fermentation.

### Optical Density

Cell density of the cultures was frequently monitored by measuring optical density at 600 nm (Implen Nanophotometer NP80, Westburg, Belgium or with a Spark 10M microplate reader, Tecan, Switzerland).

### Analytical Analysis

Standards such as but not limited to sucrose, lactose, N-acetyllactosamine (LacNAc, Gal-b1,4-GlcNAc), lacto-N-biose (LNB, Gal-b1,3-GlcNAc), fucosylated LacNAc (2′FLacNAc, 3-FLacNAc), sialylated LacNAc, (3′SLacNAc, 6′SLacNAc), fucosylated LNB (2′FLNB, 4′FLNB), lacto-N-triose II (LN3), lacto-N-tetraose (LNT), lacto-N-neo-tetraose (LNnT), LNFP-I, LNFP-II, LNFP-III, LNFP-V, LNFP-VI, LSTa, LSTc and LSTd were purchased from Carbosynth (UK), Elicityl (France) and IsoSep (Sweden). Other compounds were analyzed with in-house made standards.

Neutral oligosaccharides were analyzed on a Waters™ Acquity H-class UPLC with Evaporative Light Scattering Detector (ELSD) or a Refractive Index (RI) detection. A volume of 0.7 μL sample was injected on a Waters™ Acquity UPLC BEH Amide column (2.1×100 mm; 130 Å; 1.7 μm) column with an Acquity UPLC BEH Amide VanGuard column, 130 Å, 2.1×5 mm. The column temperature was 50° C. The mobile phase consisted of a ¼ water and ¾ acetonitrile solution to which 0.2% triethylamine was added. The method was isocratic with a flow of 0.130 mL/min. The ELS detector had a drift tube temperature of 50° C. and the N2 gas pressure was 50 psi, the gain 200 and the data rate 10 pps. The temperature of the RI detector was set at 35° C.

Sialylated oligosaccharides were analyzed on a Waters™ Acquity H-class UPLC with Refractive Index (RI) detection. A volume of 0.5 μL sample was injected on a Waters™ Acquity UPLC BEH Amide column (2.1×100 mm; 130 Å; 1.7 μm). The column temperature was 50° C. The mobile phase consisted of a mixture of 70% acetonitrile, 26% ammonium acetate buffer (150 mM) and 4% methanol to which 0.05% pyrrolidine was added. The method was isocratic with a flow of 0.150 mL/min. The temperature of the RI detector was set at 35° C.

Both neutral and sialylated sugars were analyzed on a Waters™ Acquity H-class UPLC with Refractive Index (RI) detection. A volume of 0.5 μL sample was injected on a Waters™ Acquity UPLC BEH Amide column (2.1×100 mm; 130 Å; 1.7 μm). The column temperature was 50° C. The mobile phase consisted of a mixture of 72% acetonitrile and 28% ammonium acetate buffer (100 mM) to which 0.1% triethylamine was added. The method was isocratic with a flow of 0.260 mL/min. The temperature of the RI detector was set at 35° C.

For analysis on a mass spectrometer, a Waters™ Xevo TQ-MS with Electron Spray Ionization (ESI) was used with a desolvation temperature of 450° C., a nitrogen desolvation gas flow of 650 L/h and a cone voltage of 20 V. The MS was operated in selected ion monitoring (SIM) in negative mode for all oligosaccharides. Separation was performed on a Waters™ Acquity UPLC with a Thermo Hypercarb column (2.1×100 mm; 3 μm) on 35° C. A gradient was used wherein eluent A was ultrapure water with 0.1% formic acid and wherein eluent B was acetonitrile with 0.1% formic acid. The oligosaccharides were separated in 55 min using the following gradient: an initial increase from 2 to 12% of eluent B over 21 min, a second increase from 12 to 40% of eluent B over 11 min and a third increase from 40 to 100% of eluent B over 5 min. As a washing step 100% of eluent B was used for 5 min. For column equilibration, the initial condition of 2% of eluent B was restored in 1 min and maintained for 12 min.

For identification of the single oligosaccharides in the mixture of oligosaccharides produced as described herein, the monomeric building blocks (e.g., the monosaccharide or glycan unit composition), the anomeric configuration of side chains, the presence and location of substituent groups, degree of polymerization/molecular weight and the linkage pattern can be identified by standard methods known in the art, such as, e.g., methylation analysis, reductive cleavage, hydrolysis, GC-MS (gas chromatography-mass spectrometry), MALDI-MS (Matrix-assisted laser desorption/ionization-mass spectrometry), ESI-MS (Electrospray ionization-mass spectrometry), HPLC (High-Performance Liquid chromatography with ultraviolet or refractive index detection), HPAEC-PAD (High-Performance Anion-Exchange chromatography with Pulsed Amperometric Detection), CE (capillary electrophoresis), IR (infrared)/Raman spectroscopy, and NMR (Nuclear magnetic resonance) spectroscopy techniques. The crystal structure can be solved using, e.g., solid-state NMR, FT-IR (Fourier transform infrared spectroscopy), and WAXS (wide-angle X-ray scattering). The degree of polymerization (DP), the DP distribution, and polydispersity can be determined by, e.g., viscosimetry and SEC (SEC-HPLC, high performance size-exclusion chromatography). To identify the monomeric components of the saccharide methods such as, e.g., acid-catalyzed hydrolysis, HPLC (high performance liquid chromatography) or GLC (gas-liquid chromatography) (after conversion to alditol acetates) may be used. To determine the glycosidic linkages, the saccharide is methylated with methyl iodide and strong base in DMSO, hydrolysis is performed, a reduction to partially methylated alditols is achieved, an acetylation to methylated alditol acetates is performed, and the analysis is carried out by GLC/MS (gas-liquid chromatography coupled with mass spectrometry). To determine the oligosaccharide sequence, a partial depolymerization is carried out using an acid or enzymes to determine the structures. To identify the anomeric configuration, the oligosaccharide is subjected to enzymatic analysis, e.g., it is contacted with an enzyme that is specific for a particular type of linkage, e.g., beta-galactosidase, or alpha-glucosidase, etc., and NMR may be used to analyze the products.

### Ash Content

The ash content is a measure of the total amount of minerals present within a food or ingredients such as oligosaccharides, whereas the mineral content is a measure of the amount of specific inorganic components present within a food, such as Ca, Na, K, Mg, phosphate, sulphate and Cl. Determination of the ash and mineral content of foods or oligosaccharides is important for a number of reasons: Nutritional labeling. The concentration and type of minerals present must often be stipulated on the label of a food or ingredient such as oligosaccharides. The quality of many foods depends on the concentration and type of minerals they contain, including their taste, appearance, texture and stability. Microbiological stability. High mineral contents are sometimes used to retard the growth of certain microorganisms. Nutrition. Some minerals are essential to a healthy diet (e.g., calcium, phosphorous, potassium and sodium) whereas others can be toxic (e.g., lead, mercury, cadmium and aluminum). Processing. It is often important to know the mineral content of foods/products during processing because this affects the physicochemical properties of foods or ingredients such as oligosaccharides.

Ash is the inorganic residue remaining after the water and organic matter have been removed by heating in the presence of oxidizing agents, which provides a measure of the total amount of minerals within a food. Analytical techniques for providing information about the total mineral content are based on the fact that the minerals (the analyte) can be distinguished from all the other components (the matrix) within a food or ingredient in some measurable way. The most widely used methods are based on the fact that minerals are not destroyed by heating, and that they have a low volatility compared to other food components. The three main types of analytical procedure used to determine the ash content of foods are based on this principle: dry ashing, wet ashing and low temperature plasma dry ashing. The method chosen for a particular analysis depends on the reason for carrying out the analysis, the type of food or ingredient analyzed and the equipment available. Ashing may also be used as the first step in preparing samples for analysis of specific minerals, by atomic spectroscopy or the various traditional methods described below.

For the sample preparation a sample whose composition represents that of the ingredient is selected to ensure that its composition does not change significantly prior to analysis. For instance, a dry oligosaccharide sample is generally hygroscopic and the selected sample should be kept under dry conditions avoiding the absorption of water. Typically, samples of 1-10 g are used in the analysis of ash content. Solid ingredients are finely ground and then carefully mixed to facilitate the choice of a representative sample. Before carrying out an ash analysis, samples that are high in moisture or in solution are generally dried to prevent spattering during ashing. Other possible problems include contamination of samples by minerals in grinders, glassware or crucibles that come into contact with the sample during the analysis. For the same reason, deionized water is used when preparing samples and the same is used in the blank sample.

Dry ashing procedures use a high temperature muffle furnace capable of maintaining temperatures of between 50° and 600° C. Water and other volatile materials are vaporized and organic substances are burned in the presence of the oxygen in air to CO₂, H₂O and N2. Most minerals are converted to oxides, sulphates, phosphates, chlorides or silicates. Although most minerals have fairly low volatility at these high temperatures, some are volatile and may be partially lost, e.g., iron, lead and mercury, for these minerals ICP-MS analysis of the product is more appropriate for quantification.

The food sample is weighed before and after ashing to determine the concentration of ash present. The ash content can be expressed on dry basis is calculated by dividing the mass of the ashed material, ingredient, or food by the mass of the dry material, ingredient, or food before ashing. Multiplied with 100, this gives the percentage of ash in the material, ingredient, or food. In a similar way the wet ash percentage can be determined for liquid products, wherein the mass of the liquid before and after ashing is used instead of the mass of the dry material, ingredient, or food.

### Heavy Metal Determination

A robust general inductively coupled plasma-mass spectrometry (ICP-MS) based method was used for the detection and quantitation for each of the following elements: arsenic (As), selenium (Se), cadmium (Cd), tin (Sn), lead (Pb), silver (Ag), palladium (Pd), platinum (Pt), mercury (Hg), molybdenum (Mo), sodium (Na), potassium (K), Calcium (Ca), Magnesium (Mg), Iron (Fe), zinc (Zn), manganese (Mn), Phosphorus (P), selenium (Se).

Nitric acid (≥65%, Sigma-Aldrich) was used for microwave digestion and standard/sample preparation. All dilutions were done using 18.2 MΩ·cm (Millipore, Bedford, MA, USA) de-ionized water (DIW). About 0.2 g of each oligosaccharide, ingredient, sample were digested in 5 mL of HNO3 using the microwave digestion (CEM, Mars 6) program 15 minutes (min) ramping time and 15 min holding time at 100 W and 50° C. followed by 15 min ramping time and 20 min holding time at 1800 W and 210° C. The samples were cooled after digestion for 30 minutes. The fully digested samples were then diluted to 50 mL with DIW.

Analyses were carried out using a standard Agilent 7800 ICP-MS, which includes the fourth-generation ORS cell system for effective control of polyatomic interferences using helium collision mode (He mode). The ORS controls polyatomic interferences using He to reduce the transmission of all common matrix-based polyatomic interferences. Smaller, faster analyte ions are separated from larger, slower interference-ions using kinetic energy discrimination (KED). All elements, except Se, were measured in He mode with a flow rate of 5 mL/min. Se was measured in High Energy He (HEHe) mode, using a cell gas flow rate of 10 mL/min. The 7800 ICP-MS was configured with the standard sample introduction system consisting of a MicroMist glass concentric nebulizer, quartz spray chamber, quartz torch with 2.5 mm i.d. injector, and nickel interface cones. The ICP-MS operating conditions are: 1550 W RF power, 8 mm sampling depth, 1.161/min nebulizing gas, autotuned lens tuning, 5 or 10 ml/min helium gas flow, 5 V KED.

### Dry Matter/Dry Solid and Moisture Content Quantification

Sartorius MA150 Infrared Moisture Analyzer is used to determine the dry matter content of the oligosaccharides. 0.5 g of oligosaccharide is weighed on an analytical balance and is dried in the infrared moisture analyzer until the weight of the sample is stable. The mass of the dried sample divided by the mass of the sample before drying gives the dry matter content (in percent) of the oligosaccharides or sample including oligosaccharides. In a similar way a liquid sample is weighed, however, the amount of liquid weighed is adapted to the expected amount of dry matter in the liquid, so the mass of the dry matter is properly measurable on an analytical balance.

A moisture analyzer measures the dry matter, but not the water content. Karl Fisher titration is used to determine the amount of water present in a powder, ingredient of food. The KF titration is carried out with a Karl Fischer titrator DL31 from Mettler Toledo using the two-component technique with Hydra-Point Solvent G and Hydra-Point titrant (5 mg H₂O/ml), both purchased from J. T. Baker (Deventer, Holland). The polarizing current for bipotentiometric end-point determination was 20 microA and the stop voltage 100 mV. The end-point criterion was the drift stabilization (15 micro gram H₂O min⁻¹) or maximum titration time (10 min).

The moisture content (MC) of sample was calculated using the following equation:

MC=V_KF W_eq 100/W_sample; where V_KF is the consumption of titrant in mL, W_eq the titer of titrant in mg H₂O/mL and W_sample the weight of sample in mg.

### Protein Quantification

For protein quantification a method is used that is compatible with reducing agents, such as reducing sugars or oligosaccharides with a reducing end. To this end, a Bradford assay (Thermo Scientific, Pierce) was used with a linear range between 1 and 1500 μg/ml. The assay was calibrated with a standard curve of BSA. The protein content of dried oligosaccharide products was quantified by dissolving a pre-weighed quantify in 18.2 MΩ·cm (Millipore, Bedford, MA, USA) de-ionized water (DIW) up to a quantity of 50% (m/v). The amount of protein is measured at 595 nm and converted to concentration with the calibration curve based on BSA.

### DNA Quantification

Production host specific DNA residue is quantified by RT-qPCR, for which specific primers on the host are designed so that residual DNA of the production host is amplified. The RT-qPCR was performed according to the standard protocol of a kit obtained from Sigma and was based on SYBR Green detection.

Total DNA is measured by means of a Threshold assay (Molecular Devices), based on an immunoassay allowing to measure as low as 2 μg of DNA in a sample in solution. Double stranded DNA is measured by means of SpectraMax® Quant™ AccuBlue™ Pico dsDNA Assay Kit (Molecular Devices) having a linear range between 5 μg and 3 ng of dsDNA.

### Endotoxin Measurement

Endotoxin in the liquid was measured by means of a LAL test. LAL tests are commercially available from Charles River, such as Endosafe, Endochrome-K, kinetic turbidimetric (KTA) LAL, or gel-clot LAL test.

### Laser Diffraction

The powder particle size can be assessed by laser diffraction. The system detects scattered and diffracted light by an array of concentrically arranged sensor elements. The software-algorithm is then approximating the particle counts by calculating the z-values of the light intensity values, which arrive at the different sensor elements. The analysis can be executed using a SALD-7500 Aggregate Sizer (Shimadzu Corporation, Kyoto, Japan) quantitative laser diffraction system (qLD).

A small amount (spatula tip) of each sample can be dispersed in 2 ml isooctane and homogenized by ultrasonication for five minutes. The dispersion will then be transferred into a batch cell filled with isooctane and analyzed in manual mode.

Data acquisition settings can be as follows: Signal Averaging Count per Measurement: 128, Signal Accumulation Count: 3, and Interval: 2 seconds.

Prior to measurement, the system can be blanked with isooctane. Each sample dispersion will be measured 3 times and the mean values and the standard deviation will be reported. Data can be evaluated using software WING SALD II version V3.1. When the refractive index of the sample is unknown, the refractive index of sugar (disaccharide) particles (1.530) can be used for determination of size distribution profiles. Size values for mean and median diameter are reported. The mean particle sizes for all samples are very similar due to the spray dryer settings used. In addition, the particle size distribution will show the presence of one main size population for all of the samples.

### ATFD (Agitated Thin Film Drier) Set-Up

For testing the principle of agitated thin film drying on oligosaccharides according to the disclosure, a model system (i.e., system A as described throughout the Examples) is used wherein the model directly translates to large scale manufacturing. The ATFD chamber was made from transparent glass to facilitate observation of the heat exchange area. The ATFD chamber was equipped with a Liebig condenser and a dropping funnel to condense and quantify the vapor release. The entire system can be operated under reduced pressure (as low as 50 mbar) using a vacuum pump. The dimensions of the lab-scale ATFD (i.e., system A) are for the inner diameter of the drying chamber 3 cm, outer diameter of the heating jacket 6 cm, diameter of the scraped surface blades 3 cm, effective length of the drying chamber 35 cm, the thickness of the wall 2 mm, the heat exchange area 330 cm² and the number of blades 2.

Solutions (such as syrups) containing an oligosaccharide or a mixture of oligosaccharides were preheated to a temperature between 3° and 100° C. and pumped to the system with a peristaltic pump with a flow ranging from 0.1 to 1 kg/h. The drying temperatures of the heating chamber ranged from 50 to 90° C., preferably at 70° C. The blades rotated at a speed of 75 to 600 rpm. The condenser was operated with cooling water of 2° C. The amount of condensed water was measured and used to obtain the evaporation rate. The specific evaporation rate was calculated by dividing the evaporation rate by the used heat exchange area.

The solutions/syrups had a dry matter content ranging from 10% to 80 wt. %. Lower concentrations of oligosaccharides can be applied.

A pilot ATFD system (i.e., system B as described throughout the Examples) was used to produce larger amounts of dried oligosaccharide. The inner diameter and length of the drying chamber is 15.1 cm and 41.7 cm, respectively. The heat exchanger area is 0.2 m². The heat exchanger area can be heated at 50-120° C. using steam. The distance between the rotor and wall is 0.9 mm. The blades can rotate at 200-2200 rpm. The condenser was operated with cooling water of 5-6° C. The amount of condensed water was measured and used to obtain the evaporation rate. The specific evaporation rate was calculated by dividing the evaporation rate by the used heat exchange area.

The following settings were applied to obtain a dry, white to off-white powder of an oligosaccharide:
10-60% (w/v) oligosaccharide in reverse osmosis water;
temperature of heated surface: 50-75° C., preferably 50-70° C.;
pressure: 10-50 mbar;
blades: 600-1200 rpm, preferably 700-1000 rpm;
feeding rate: 1-10 kg/h, preferably 5-9 kg/h.

### Spray Drying of Oligosaccharide(s) Containing Solution

A spray drying system was used with an evaporation capacity of 25 kg/h. For spray drying, the solution was heated to a temperature between 50° C. and 100° C. and the pH of the solution set at 4-5. The oligosaccharide concentration in the feed is between 20% and 80% brix as obtained by rotary evaporation. The concentrated solution was fed to the spray dryer at a rate between 50 and 90% (the higher the percentage brix, the faster the feed rate). The used inlet temperature is 120° C.-280° C. (specifically 184° C.) and the outlet temperature 100° C.-180° C. (specifically 110° C.). The atomizer wheel rotation speed was set at 10000-28000 rpm (specifically 21500 rpm). The obtained powder had a water content of about 5-6%.

### Example 2: Synthesis of Oligosaccharides

An E. coli strain producing 2-fucosyllactose as described in WO2013087884A1 and further modified as described in WO21122708 was used in a fed batch fermentation as described in Example 1. The fermentation medium contained 120 g/l of lactose and 100 g/l of sucrose in the batch medium and a 60% sucrose solution was fed to the bioreactor. The lactose concentration in the bioreactor is modulated by the amount of sucrose was fed, in a preferred example the lactose was converted to a concentration in the supernatant lower than 5 g/l.

The medium composition is described in example 1. The final titer reached in the fermentation was 150 g/l.

An E. coli strain producing 6′sialyllactose or 3′sialyllactose as described in WO2018122225 was used in a fed batch fermentation as described in example 1. The fermentation medium contained 100 g/l of lactose and 60 g/l of sucrose and was fed with a 60% sucrose solution until the lactose concentration in the supernatant was lower than 5 g/l. The final titer reached in the fermentation was 100 g/l of either 6′SL or 3′SL.

An E. coli strain adapted for sialic acid production as described in WO2018122225 was further modified with a genomic knock-out of the E. coli wcaJ gene to increase the intracellular pool of GDP-fucose and genomic knock-ins of constitutive expression cassettes for the LgtA gene from N. meningitidis and the WbgO gene from E. coli 055:H7. In a next step, the novel strain was transformed with two compatible expression plasmids wherein a first plasmid pMF_2 contained (a) constitutive expression unit(s) for two fucosyltransferase genes, H. pylori alpha-1,2-fucosyltransferase gene (HpFutc) and the H. pylori alpha-1,3-fucosyltransferase gene (HpFucT), and wherein a second plasmid pMS_2 contained constitutive expression units for two sialyltransferase genes, alpha-2,3-sialyltransferase from P. multocida and alpha-2,6-sialyltransferase (PdST6) from Photobacterium damselae, and the NeuA gene from P. multocida coding for N-acylneuraminate cytidylyltransferase. This strain produces an oligosaccharide mixture comprising fucosylated and sialylated lactose, LNB, fucosylated and sialylated LNB, LN3, sialylated LN3, LNT and fucosylated and sialylated LNT structures in whole broth samples. The strain was grown in an experiment according to the culture conditions provided in Example 1 in which the cultivation contains sucrose as carbon source and lactose as precursor.

This mutant strain is evaluated in a batch and fed-batch fermentation process in a 5 L and 30 L bioreactor as described in Example 1. In this example sucrose is used as a carbon source and lactose is added in the batch medium as precursor. Regular broth samples are taken, and sugars produced are measured as described in Example 1. UPLC analysis shows that fermentation broth of the selected strain taken at regular timepoints in fed-batch phase contains an oligosaccharide mixture comprising 2′FL, 3-FL, DiFL, 3′SL, 6′SL, di-SL, 3'S-2′FL, 3'S-3-FL, 6'S-2′FL, 6'S-3-FL, LNB, 2′FLNB, 4-FLNB, Di-FLNB, 3′SLNB, 6′SLNB, LN3, 3'S-LN3, 6'S-LN3, LNT, LNFP-I, LSTa.

A mutant E. coli strain for LNnT (Lacto-N-neotetraose) is modified with constitutive transcriptional unit of N-acetylglucosamine beta-1,4-galactosyltransferase gene (LgtB) from N. meningitidis in one or more copies. To enhance UDP-galactose production the genes ushA and galT are knocked out. The mutant E. coli strains is further modified with a genomic knock-in of a constitutive transcriptional unit for the UDP-glucose-4-epimerase gene (galE) gene from E. coli, the phosphoglucosamine mutase (glmM) gene from E. coli and the N-acetylglucosamine-1-phosphate uridyltransferase/glucosamine-1-phosphate acetyltransferase (glmU) gene from E. coli. The mutant strain is further mutated for growth on sucrose via genomic knock-ins of constitutive transcriptional units containing a sucrose transporter (CscB) gene from E. coli W, a fructose kinase gene (Frk) originating and a sucrose phosphorylase originating from B. adolescentis. The final mutant strain produces Lacto-N-neotetraose (LNnT), this mutant strain is evaluated in a batch and fed-batch fermentation process in a 5 L and 30 L bioreactor as described in Example 1. In this example sucrose is used as a carbon source and lactose is added in the batch medium as precursor. Regular broth samples are taken, and sugars produced are measured as described in Example 1. UPLC analysis shows that fermentation broth of the selected strain taken at regular timepoints in fed-batch phase contains Lacto-N-neotetraose (LNnT).

A mutant E. coli strain for LNT (Lacto-N-tetraose) is modified with constitutive transcriptional unit of N-acetylglucosamine beta-1,3-galactosyltransferase gene (wbgO) from E. coli 055:H7 in one or more copies. To enhance UDP-galactose production the genes ushA and galT are knocked out. The mutant E. coli strains is further modified with a genomic knock-in of a constitutive transcriptional unit for the UDP-glucose-4-epimerase gene (galE) gene from E. coli, the phosphoglucosamine mutase (glmM) gene from E. coli and the N-acetylglucosamine-1-phosphate uridyltransferase/glucosamine-1-phosphate acetyltransferase (glmU) gene from E. coli. The mutant strain is further mutated for growth on sucrose via genomic knock-ins of constitutive transcriptional units containing a sucrose transporter (CscB) gene from E. coli W, a fructose kinase gene (Frk) originating and a sucrose phosphorylase originating from B. adolescentis.

The final mutant strain produces Lacto-N-tetraose (LNT). This mutant strain is evaluated in a batch and fed-batch fermentation process in a 5 L and 30 L bioreactor as described in Example 1. In this example sucrose is used as a carbon source and lactose is added in the batch medium as precursor. Regular broth samples are taken, and sugars produced are measured as described in Example 1. UPLC analysis shows that fermentation broth of the selected strain taken at regular timepoints in fed-batch phase contains an oligosaccharide Lacto-N-tetraose (LNT).

### Example 3: Composition Determination of the Fermentation Broth

For the fermentation broths obtained in Example 2 the composition was determined by measuring the cell dry mass of the broth, the ash content of the supernatant and the broth, the oligosaccharide content of the supernatant and the broth and the total dry solids in the broth in accordance with the methods described in Example 1. For all samples, the total oligosaccharide content was below 80% on total dry solids. The oligosaccharide mixture purity in the broth ranged from 30% to 77%.

### Example 4: Broth Clarification

The broth originating from the cultivation or fermentation and, as the case may be, lysis step, are further clarified through microfiltration. The lysis is obtained by heating the broth for 1 hour at a temperature between 60° C. and 80° C. For filtration, several types of microfiltration membranes have been used to clarify the fermentation broth with a pore size ranging between 0.1 to 10 m (ceramic, PES, PVDF membranes). The membrane types were first used as dead-end filtration and further optimization was performed in cross flow filtration. The cross-flow microfiltration was followed by diafiltration to increase product yield after this purification step. The membranes are capable of separating large, suspended solids such as colloids, particulates, fat, bacteria, yeasts, fungi, cells, while allowing sugars, proteins, salts, and low molecular weight molecules to pass through the membrane.

The particle concentration in the filtrate was measured with a spectrophotometer through light adsorption at 600 nm. This method allows the validation of particle removal and filtration optimization.

Alternative to microfiltration membranes, ultrafiltration membranes are used. Ultrafiltration membranes with a cut-off between 1000 Da and 10 kDa were tested (microdyne Nadir (3 kDa PES), Synder (3 kDa, PES), Synder Filtration MT (5 kDa, PES) and Synder Filtration ST (10 kDa, PES)). Alternative membranes with larger cut-offs will also work for broth clarification. The membranes were used in cross flow mode, and diafiltrations were applied similar to the microfiltration operation described above to increase product yield. The filtration efficiency is evaluated based on the particle concentration of the filtrate. Apart from cells and cell debris, membranes below 10 kDa efficiently remove DNA, protein and endotox, which were measured with the methods described in example 1. Higher cut-off membranes between 10 and 500 kDa remove cell mass efficiently, but do not retain smaller molecular weight products as efficiently, therefore requiring an additional Ultrafiltration step with a molecular weight cut-off below 10 kDa. A final recovery through ultrafiltration for broth clarification of Above 95% was obtained.

To enhance broth clarification through centrifugation, flocculants/coagulants have been used. Generally, gypsum, alum, calcium hydroxide, polyaluminum chloride, Aluminum chlorohydrate, are used as good flocculation agents. These flocculants were applied at a pH>7 and at temperatures between 4° C. and 20° C., more preferably between 4° C. and 10° C. pH<7 released toxic cations that are removed further through cation exchange. Alternative flocculants tested are based on polyacrylamide or biopolymer (chitosan), Floquant (SNF inc), Superfloc (Kemira) or hyperfloc (Hychem inc), Tramfloc. These flocculants were used in different concentrations: 0.05, 0.1 and 0.2 v/v % after diluting the broth 1:1 with RO-water, they were directly added to the broth and gently mixed for 10 minutes at room temperature. pH was kept at neutral conditions, between pH 6 and 7. At higher pH some degradation of the flocculant occurs, leading to compounds that are removed by means of ion exchange.

To test flocculation efficiency centrifugation was performed at 4000 g and the pellet strength and supernatant turbidity was evaluated after different centrifugation times. The oligosaccharide yield was measured by measuring the oligosaccharide supernatant concentration and the total supernatant volume. The pellet was washed several times to increase the release of oligosaccharides. A final oligosaccharide recovery between 90 and 98% was obtained.

### Example 5: Ultrafiltration

Ultrafiltration was performed on a Colossus apparatus (Convergence Industry, The Netherlands) controlled by a PC running Convergence Inspector software. Temperature, pressures and conductivity of both retentate and filtrate were measured inline, pH was measured offline with a calibrated pH probe (Hanna Instruments). The membrane to further remove DNA, protein and endotoxin was a 10 kDa membrane based on PES (Synder), used in crossflow. After filtration, the DNA, protein and endotoxin content was measured in the filtrate as described in Example 1. The protein content was below 100 mg per kg dry solid, the DNA content below 10 ng per gram dry solid and the endotoxin was below 10000 EU per gram dry solid. No DNA from the production hosts could be detected in the filtrate.

Although in this example a polysulfon based membrane was used, other membrane materials will perform equally, these membrane materials can be a ceramic or made of a synthetic or natural polymer, e.g., polypropylene, cellulose acetate or polylactic acid from suppliers such as Synder, Tami, TriSep, Microdyn Nadir, GE.

### Example 6: Nanofiltration

A fraction of the product obtained in Example 5 after ultrafiltration was treated by means of nanofiltration. Nanofiltration is used to either concentrate the oligosaccharide solution, in which case also reversed osmosis can be used or remove impurities, such as monosaccharide formed during the fermentation or purification process or organic acids, alcohols or other impurities formed in the production process or salts or chemicals added for the production process.

Tangential flow nanofiltration was performed on a Colossus apparatus (Convergence Industry, The Netherlands) controlled by a PC running Convergence Inspector software. Temperature, pressures and conductivity of both retentate and filtrate were measured inline, pH was measured offline with a calibrated pH probe (Hanna Instruments). Clarified liquid treated with ultrafiltration from example 12 was further subjected to nanofiltration and sequential diafiltrations. To this end a polyamide base membrane with a cut off between 300 and 500 Da was used (TriSep XN-45 (TriSep Corporation, USA)) at 40° C. The diafiltrations were done with deionized water with a total volume of 5 times the volume of the oligosaccharide mixture concentrate. This step reduced the disaccharide fraction on dry solid below 5% and reduced the total ash content of the liquid with 50%. The concentration of the oligosaccharide mixture was increased to about 200 g/l.

### Example 7: Ion Removal Through Electrodialysis

The ED equipment used is a PCCell ED 64004 lab-scale ED stack, fitted with 5 cell pairs of the PC SA and PC SK standard ion-exchange membranes. The initial diluate and concentrate both consisted of 1.5 L of the feed stream obtained after the clarification and ultrafiltration in Examples 4 and 5. The liquids obtained in these Examples contained oligosaccharides and cations and anions with an ash content above 10% on dry solid. The desalination was done against a concentration gradient. Both streams are recirculated while a constant voltage of 7.5V is applied and the current and conductivity are monitored. Samples are taken at the beginning and end and periodically during the experiment. Water transport across the membranes is monitored by measuring the volume of all streams at the end of the experiment. To ensure efficient transfer of the current to the stack, an electrolyte solution of 60 g/L NaNO3 is recirculated at the electrodes.

The ED experiment was maintained until a stabilization of the current and conductivity was noticed. This indicates the point where desalination becomes slow and more inefficient. The conductivity decreases from 3.79 mS/cm in the feed to 0.88 mS/cm at the end of the experiment, indicating an overall desalination of 77%. The multivalent anions were removed up to 90%. The final oligosaccharide recovery was between 90 and 99%. The ash content on dry solid after electrodialysis was about 2.5% on dry solid.

### Example 8: Ion Removal Through Ion Exchange

To remove ions from the broth to an ash content <1%, first a cation exchange and second an anion exchange step was performed. Depending on the mixture of oligosaccharides different anion exchange resins were selected to enhance the yield of the purification step.

For clarified broths originating from Examples 4, 5, 6 and 7 containing non-charged oligosaccharides, were first passed through a strong acid cation exchange resin containing column (1 L of Amberlite IR120) in the proton form at a temperature of 10° C., resulting in exchange of all cations with a proton in the liquid. The liquid resulting from the cation exchange step was subjected to a weak base anion exchange resin containing column (1 L of Amberlite IR400) in the hydroxide form at a temperature of 10° C., exchanging the anions in the liquid for hydroxide ions. After both cation and anion exchange, the pH was set to a pH between 6 and 7. The oligosaccharide recovery was between 95 and 98%.

Alternative cation and anion exchange resins are Amberlite IR100, Amberlite IR120, Amberlite FPC22, Dowex 50WX, Finex CS16GC, Finex CS13GC, Finex CS12GC, Finex CS11GC, Lewatit S, Diaion SK, Diaion UBK, Amberjet 1000, Amberjet 1200 and Amberjet 4200, Amberjet 4600, Amberlite IR400, Amberlite IR410, Amberlite IR458, Diaion SA, Diaion UBA120, Lewatit MonoPlus M, Lewatit S7468. The cation and anion exchange treated liquids were then tested on ash, oligosaccharide content and heavy metal content. The ash content after treatment was below 0.5% (on total dry solid), the Lead content was lower than 0.1 mg/kg dry solid, Arsenic: lower than 0.2 mg/kg dry solid, Cadmium lower than 0.1 mg/kg dry solid and Mercury was lower than 0.5 mg/kg dry solid.

For clarified broths originating from Examples 4, 5, 6 and 7, specific anion exchange resins were used that do not retain the charged oligosaccharides (containing a sialyl group). These resins are characterized to have a moisture content of 30-48% and preferably a gel type anion exchanger. Examples of such resins are DIAION SA20A, Diaion WA20A (Mitsubishi), XA4023 (Applexion), Dowex 1-X8 (Dow). In a first step the liquid was first passed through a strong acid cation exchange resin containing column (1 L of Amberlite IR120) in the proton form at a temperature of 10° C., resulting in exchange of all cations with a proton in the liquid. This was then passed immediately through an anion exchange resin column (1 L of XA4023), exchanging salts like phosphates and sulphates for hydroxide ions. The resulting liquid was set to a pH between 5 and 7. The ash content corrected for the sodium counter ions for the sialylated oligosaccharides was below 1% (on total dry solid) after ion exchange treatment, the Lead content was lower than 0.1 mg/kg dry solid, Arsenic: lower than 0.2 mg/kg dry solid, Cadmium lower than 0.1 mg/kg dry solid and Mercury was lower than 0.5 mg/kg dry solid.

An alternative to sequential cation and anion exchange steps is mixed bed ion exchange. The resins are mixed in a ratio typically within the range of 35:65 and 65:35 volume percentage. Typically, a mixed bed ion exchange step is introduced in the process after a first de-ionization step such as a nanofiltration step, an electrodialysis step or ion exchange step but is also used as sole ion exchange step. For the oligosaccharide mixtures obtained in Examples 4, 5, 6, and 7, the clarified broth after ultrafiltration in Example 5, the liquids were subjected to a mixed bed column of Amberlite FPC 22H and Amberlite FPA51 mixed in a ratio 1:1.3 on a 1 L column. The mixed bed step was performed at a temperature between 4° C. and 10° C. Finally, the liquid was set to a pH between 5 and 7 and the ash content of the solution was measured to be below 1%. The oligosaccharide recovery was between 95 and 98%.

For clarified broths originating from Examples 4, 5, 6 and 7, after ultrafiltration in Example 5, the liquids were subjected to a mixed bed column of Diaion SA20A and Amberlite FPC 22H mixed in a ratio 1.3:1 on a 1 L column. Similar to the above the mixed bed step was performed at a temperature between 4° C. and 10° C. Finally, the liquid was set to a pH between 5 and 7 and the ash content of the solution was measured to be below 1%. None of the sialylated oligosaccharides were retained in this step, retaining the mixture composition, the oligosaccharide recovery was between 95 and 98%.

### Example 9: Concentration Through Nanofiltration

Nanofiltration was carried out with an NF-2540 membrane (DOW) with a cut off of 200 Da to concentrate the de-ionized solutions after ion exchange, electrodialysis or nanofiltration up to 25 Brix. During the filtration process a pressure across the membrane in the range of 20-25 bar was used and a process temperature of 45° C. The solution was continuously recirculated over the membrane for concentration, leading to a dry matter content of the concentrate up to 25% Brix.

### Example 10: Color Removal

To achieve decolorization, several samples from Examples 4, 5, 6, 7, 8 and 9 were subjected to activated charcoal treatment with Norit SX PLUS activated charcoal (0.5% m/v). Color removal was measured with a spectrophotometer at 420 nm. In all samples the color intensity at 420 nm was reduced 50- to 100-fold. The activated charcoal is filtered off by means of a plate filter or chamber filter press preferably at elevated temperatures.

### Example 11: ATFD Using System A

A fraction of the product obtained in Example 5 after ultrafiltration is used in a drying experiment by means of the agitated thin film drying method as described in Example 1 (ATFD system A). The liquids originating from the ultrafiltration contained an oligosaccharide concentration between 10 and 50 g/l and were dried to a powder with a water content less than 10% mass on mass. The ash content of this powder was higher than 20%.

A fraction of the product obtained in Example 6 after nanofiltration is used in a drying experiment by means of the agitated thin film drying method as described in Example 1 (ATFD system A). The liquids originating from the ultrafiltration contained an oligosaccharide concentration between 100 and 200 g/l and were dried to a powder with a water content less than 10% mass on mass. The ash content of this powder was less than 10%.

A fraction of the product obtained in Example 7 after electrodialysis is used in a drying experiment by means of the agitated thin film drying method as described in Example 1 (ATFD system A). The liquids originating from the ultrafiltration contained an oligosaccharide concentration between 100 and 200 g/l and were dried to a powder with a water content less than 10% mass on mass. The ash content of this powder was less than 10%, more specifically lower than 5%, even more specifically lower than 3%, even more specifically lower than 1%.

A fraction of the product obtained in Example 8 after ion exchange is used in a drying experiment by means of the agitated thin film drying method as described in example 1 (ATFD system A). The liquids originating from the ion exchange contained an oligosaccharide concentration between 100 and 200 g/l and were dried to a powder with a water content less than 10% mass on mass. The ash content of this powder was less than 10%, more specifically lower than 5%, even more specifically lower than 3%, even more specifically lower than 1%.

A fraction of the product obtained in Example 9 after nanofiltration concentration is used in a drying experiment by means of the agitated thin film drying method as described in example 1 (ATFD system A). The liquids originating from the nanofiltration contained an oligosaccharide concentration between 100 and 200 g/l and were dried to a powder with a water content less than 10% mass on mass. The ash content of this powder was less than 10%, more specifically lower than 5%, even more specifically lower than 3%, even more specifically lower than 1%.

A fraction of the product obtained in Example 10 after color removal is used in a drying experiment by means of the agitated thin film drying method as described in Example 1 (ATFD system A). The liquids originating from the color removal contained an oligosaccharide concentration between 100 and 200 g/l and were dried to a powder with a water content less than 10% mass on mass. The ash content of this powder was less than 10%, more specifically lower than 5%, even more specifically lower than 3%, even more specifically lower than 1%.

### Example 12: ATFD Using System B

2′-fucosyllactose (2′FL) was recombinantly produced in E. coli according to Example 2, followed by a cell lysis treatment and/or broth clarification according to Example 4. The clarified broth was finally spray dried as described in Example 1 to obtain 2′FL powder (purity 96.02%). A solution (8.1 kg) of 2′FL was then prepared in reverse osmosis water such that the dry weight (i.e., 2′FL) is 20.13%. The 2′FL solution was then fed into the ATFD system B (it is referred to Example 1) at 6.8 kg/h. The temperature of the heated surface was set at 64° C.; pressure at 40 mbar and rotor speed at 800 rpm. Every 5 minutes, a sample of the obtained powder was analyzed according to Example 1 (dry matter content, moisture content, oligosaccharide analysis, color). After 15 minutes and at each subsequent time-point during the 1-hour run, a white to off-white powder was obtained with a mean moisture content of 2.47%. The oligosaccharide analysis demonstrated that less than 4% of the 2′FL is broken down at the end of the 1-hour run.

Lacto-N-neotetraose (LNnT) was recombinantly produced in E. coli according to Example 2, followed by a cell lysis treatment and/or broth clarification according to Example 4. The clarified broth was finally spray dried as described in Example 1 to obtain a powder comprising LNnT (74%), pLNnH (13%; para-lacto-N-neohexaose) and LNT-II (3%; lacto-N-triose II). A solution (16.1 kg) of LNnT was then prepared in reverse osmosis water such that the dry weight is 19.60%. The LNnT solution was then fed into the ATFD system B (it is referred to Example 1) at 7.7 kg/h. The temperature of the heated surface was set at 64° C.; pressure at 20 mbar and rotor speed at 850 rpm. Every 5 minutes, a sample of the obtained powder was analyzed according to Example 1 (dry matter content, moisture content, oligosaccharide analysis, color). After 30 minutes and at each subsequent time-point during the 2-hour run, a white to off-white powder was obtained with a mean moisture content of 5.5%. The oligosaccharide analysis demonstrated that less than 10% of the oligosaccharides is broken down at the end of the 2-hour run. The bulk density (assessed using ASTM D1895 method A, i.e., ISO Method R 60) of the obtained LNnT powder during the run is on average 509+/−16 g/L. This is significantly higher than the bulk density of the spray dried powder (368 g/L).

6′-sialyllactse (6′SL) was recombinantly produced in E. coli according to Example 2, followed by a cell lysis treatment and/or broth clarification according to Example 4. The clarified broth was finally spray dried as described in Example 1 to obtain 6′SL powder (purity 94%). A solution (16 kg) of 6′SL was then prepared in reverse osmosis water such that the dry weight (i.e., 6′SL) is 19.54%. The 6′SL solution was then fed into the ATFD system B (it is referred to Example 1) at 7.7 kg/h. The temperature of the heated surface was set at 64° C. for run 1 and 2 or 70° C. for run 3; pressure at 20 mbar and rotor speed at 800 rpm (runs 1 and 3) or 850 rpm (run 2). Every 5 minutes, a sample of the obtained powder was analyzed according to Example 1 (dry matter content, moisture content, oligosaccharide analysis, color). For each run, after 20 minutes and at each subsequent time-point during the 2-hour run, a white to off-white powder was obtained with a mean moisture content of 6.2-6.8%. The oligosaccharide analysis demonstrated that less than 10% of the 6′SL is broken down at the end of the 2-hour run. The bulk density (assessed using ASTM D1895 method A, i.e., ISO Method R 60) of the obtained 6′SL powder during the run is on average 521+/−10 g/L. This is significantly higher than the bulk density of the spray dried powder (321 g/L).

### LIST OF REFERENCES

Cammerer et al., Eur. Food Res. Technol. 1999, 209(3-4), 261-265.
Coppa et al., 2013, Ital. J. Pediatr. 2013, 39(2).
Fagerson, I. S., J. Agric. Food Chem. 1969, 17(4), 747-750.
Faijes et al., Biotechnology Advances 2019, 37(5), p. 667-697.
Ghosh et al., Chem. Asian J. 2020, 15(4), p. 450-462.
Ishwarya, S. P., Chapter 5: Spray Drying, 57-94, In Anandharamakrishnan, C. (Editor)—Handbook of Drying for Dairy Products, ISBN: 9781118930526.
Kruschitz and Nidetzky, Biotechnology Advances 2020, 43: 107568.
Li et al., Chemical Industry and Engineering Progress 2015, 34(11), p. 4108-4113.
Li et al., International Journal of Biological Macromolecules 2020, 152, p. 199-206.
Li and Ye, Current Opinion in Chemical Biology 2020, 58, p. 20-27.
Lu et al., ACS Synth. Biol. 2021, 10(5), p. 923-938.
Remington: The Science and Practice of Pharmacy, 20th Edition. Baltimore, MD: Lippincott Williams & Wilkins, 2000.
Urashima T. et al., 2011, Milk Oligosaccharides, Nova Biomedical Books, New York ISBN 978-1-61122-831-1.
Urashima et al., 2013, Biosci. Biotechnol. Biochem. 77(3): p. 455-466.
Van der Fels-Klerx, H. J. et al., Food Res. Int. 2014, 57, 210-217.
Vera et al., Current opinion in food science 2021, 37, p. 160-170.
Walsh et al., J. Functional Foods 2020, 72: 104052.
Wei et al., 2018, Sci. Rep. 8:4688.
Wilson, K. et al., 2014, Chapter 19, Bio-based chemicals from biorefining:
carbohydrate conversion and utilization, 624-658, In Waldron, K. (Editor), Advances in Biorefineries: Biomass and Waste Supply Chain Exploitation, ISBN: 978-0-85709-521-3.
Woo, M. W. et al. 2013, Chapter 2, Spray drying for food powder production, 29-56, In Bhandari, B., Bansal, N., Zhang, M., Schuck, P., (Editors) Handbook of Food Powders, Processes and Properties, ISBN: 978-O-85709-513-8.
Wrigglesworth et al., 2020, PLoS ONE 15(12).
WO2009/113861
WO2013/087884
WO2018/122225
WO2021/067641
WO2021/142241
WO2021/122708
WO2021/242866

1.-25. (canceled)

26. A method for drying at least one oligosaccharide, the method comprising:
providing a solution comprising the at least one oligosaccharide, and
applying the solution to an agitated thin film dryer,
wherein the at least one oligosaccharide (i) has a degree of polymerization (DP) that is less than 16 and (ii) is isolated from a microbial cultivation or fermentation, cell culture, enzymatic reaction, or chemical reaction.

27. The method according to claim 26, wherein at least one oligosaccharide is obtained from an in vitro and/or ex vivo culture of cells.

28. The method according to claim 26, further comprising:
cultivating at least one cell that is able to produce the at least one oligosaccharide in a suitable cultivation medium to form a cultivation broth, and
purifying the at least one oligosaccharide from the cultivation broth by:
clarifying the cultivation broth,
removing salts and/or medium components form the clarified cultivation broth, and/or
concentrating the at least one oligosaccharide in the clarified cultivation broth,
thereby providing a solution comprising the purified oligosaccharide
so as to provide the solution.

29. A method of producing a purified oligosaccharide or a mixture of at least two different oligosaccharides, the method comprising:
(a) cultivating at least one cell that is able to produce the oligosaccharide or the mixture of at least two different oligosaccharides in a suitable cultivation medium to form a cultivation broth;
(b) purifying the oligosaccharide or the mixture from the cultivation broth by clarifying the cultivation broth, and:
(i) removing salts and/or medium components from the clarified cultivation broth, and/or
(ii) concentrating the oligosaccharide or mixture in the clarified cultivation broth thereby providing a solution comprising the purified oligosaccharide or the purified mixture of at least two different oligosaccharides; and
(c) applying the provided solution to an agitated thin film dryer.

30. The method according to claim 26, wherein the oligosaccharide or each oligosaccharide of the mixture has a degree of polymerization of at least three.

31. The method according to claim 26, wherein the oligosaccharide or each oligosaccharide of the mixture has a degree of polymerization of less than 10.

32. The method according to claim 26, wherein the oligosaccharide or any one of the oligosaccharides in the mixture has a solubility of at least 200 g/L in an aqueous solution and at ambient temperature.

33. The method according to claim 26, wherein the oligosaccharide or any one of the oligosaccharides in the mixture is a milk oligosaccharide, an antigen of the human ABO blood group system, a Lewis-type antigen oligosaccharide, an animal oligosaccharide, or a plant oligosaccharide.

34. The method according to claim 26, wherein the at least one oligosaccharide is a milk oligosaccharide.

35. The method according to claim 34, wherein the milk oligosaccharide comprises a lactose at its reducing end.

36. The method according to claim 26, wherein the solution is an aqueous solution comprising at least 90% w/w water.

37. The method according to claim 26, wherein the agitated thin film dryer is configured for agitated thin film drying of the solution.

38. The method according to claim 26, wherein the temperature of the heated surface of the agitated thin film dryer is at least 40° C.

39. The method according to claim 26, wherein the temperature of the heated surface of the agitated thin film dryer is ≤80° C.

40. The method according to claim 26, wherein the solution is dried at a pressure of ≤50 mbar.

41. The method according to claim 26, wherein the solution is applied such that it forms a film on the heated surface of the agitated thin film dryer, wherein the film has a height of at least 0.1 mm.

42. The method according to claim 26, so as to obtain a dried powder.

43. The method according to claim 42, wherein the dried powder contains ≤10 wt. percent of liquid.

44. The method according to claim 42, wherein the oligosaccharide or the mixture of oligosaccharides constitutes at least 70% of the total weight of dry matter within the dried powder.

45. The method according to claim 42, wherein the powder has a bulk density which is higher than what is obtained with spray drying of the solution.

46. The method according to claim 42, further comprising mixing the dried powder together with a pharmaceutically acceptable carrier, filler, preservative, solubilizer, diluent, excipient, salt, adjuvant, and/or solvent.

47. The method according to claim 42, wherein the dried powder has a white to off-white color.

48. The method according to claim 26, wherein the solution is applied such that it forms a film on the heated surface of the agitated thin film dryer, wherein the film has a height of less than 10 mm.
